(19) United States
(12) Patent Application Publication
(10) Pub. No.: US 2025/0053198 A1
(43) Pub. Date: Feb. 13, 2025

(54) ELECTRONIC DEVICE HAVING FLEXIBLE DISPLAY MODULE

(71) Applicant: SAMSUNG ELECTRONICS CO., LTD., Suwon-si (KR)

(72) Inventors: Wonsun LEE, Suwon-si (KR); Gyejoon YOO, Suwon-si (KR); Hosoon LEE, Suwon-si (KR); Yena SHIN, Suwon-si (KR); Junho LEE, Suwon-si (KR); Jinsoo CHOI, Suwon-si (KR); Jinwan AN, Suwon-si (KR)

(73) Assignee: SAMSUNG ELECTRONICS CO., LTD., Suwon-si (KR)

(21) Appl. No.: 18/930,650

(22) Filed: Oct. 29, 2024

Related U.S. Application Data
(63) Continuation of application No. PCT/KR2023/003037, filed on Mar. 6, 2023.

(30) Foreign Application Priority Data
Apr. 29, 2022 (KR) 10-2022-0053448
Aug. 31, 2022 (KR) 10-2022-0110117

(51) Int. Cl. G06F 1/16

(52) U.S. Cl. CPC G06F 1/1641; G06F 1/1616; G06F 1/1624; G06F 1/1652; G06F 1/1681

(57) ABSTRACT

An electronic device includes a housing, a display module having a first region, a second region and a third region between the first region and the second region. The display module comprises a window including a first portion having a first thickness in the first region, a second portion having a second thickness in the second region, the second thickness being less than the first thickness, and a recessed portion in the third region. The display module comprises an adhesive member disposed on at least one surface of the window. The display module comprises a display panel attached to the window. The recessed portion has a first radius of curvature between the first region and the third region, a second radius of curvature between the second region and the third region, and a third radius of curvature at a point having a minimum thickness in the recessed portion.

### CROSS-REFERENCE TO RELATED APPLICATIONS

This application is a continuation of International Application No. PCT/KR2023/003037, filed on Mar. 6, 2023, in the Korean Intellectual Property Receiving Office, which is based on and claims priority to Korean Patent Application No. 10-2022-0110117, filed on Aug. 31, 2022, in the Korean Intellectual Property Office, and Korean Patent Application No. 10-2022-0053448, filed on Apr. 29, 2022, in the Korean Intellectual Property Office, the disclosures of which are incorporated by reference herein in their entireties

### BACKGROUND

### 1. Field

The present disclosure relates to an electronic device having a flexible display module.

### 2. Description of Related Art

Along with the development of electronic, information, and communication technologies, various functions are integrated into a single mobile communication device or electronic device. For example, a smartphone, in addition to its communication capability, may further include various functions such as a sound reproduction device, a photographing camera, an electronic notebook or the like, and more various functions may be implemented in such a smartphone through additional installation of an application.

As the use of personal or mobile communication devices, such as smartphones, becomes more common, demand for portability and convenience of uses is increasing. For example, a touch screen display may serve as an output device for outputting a screen (for example, visual information), and may also serve as a virtual keypad that replaces a mechanical input device (e.g., a button-type input device). Thus, mobile communication devices or electronic devices may be further miniaturized while still providing substantially the same or more improved usability (e.g., larger screens). On the other hand, as flexible displays, such as foldable or rollable displays, are more commercialized in the market, the portability and convenience of use of those electronic devices are expected to be further improved.

### SUMMARY

Provided is an electronic device that may minimize delamination between a glass member provided in a display module and an adhesive member bonded to the glass member.

According to an aspect of the disclosure, an electronic device may include a housing, a display module having a first region, a second region and a third region between the first region and the second region. The display module may comprise a window including a first portion having a first thickness in the first region, a second portion having a second thickness in the second region, the second thickness being less than the first thickness, and a recessed portion in the third region. The display module may comprise an adhesive member disposed on at least one surface of the window. The display module may comprise a display panel attached to the window. The recessed portion may have a first radius of curvature between the first region and the third region, a second radius of curvature between the second region and the third region, and a third radius of curvature at a point having a minimum thickness in the recessed portion.

The first radius of curvature may be greater than or equal to at least one of the second radius of curvature and the third radius of curvature.

The recessed portion may include a first curved portion having the first radius of curvature, a second curved portion having the second radius of curvature, and a third curved portion having the third radius of curvature, and the first curved portion may include an inclined portion having an inclination of 1 degree or less.

A first outer edge forming a boundary between the first region and the third region may be positioned opposite to a second outer edge forming a boundary between the second region and the third region.

The recessed portion may be on a first surface of the window, and a second surface of the window that is opposite to the first surface of the window may be flat.

The recessed portion may be on a first surface of the window and a second surface of the window that is opposite the first surface of the window.

The display module may be configured to be folded at the second region and the third region while the first region remains flat.

At a boundary between the first region and the third region, the recessed portion may have the first thickness, and, at a boundary between the second region and the third region, the recessed portion may have the second thickness.

The recessed portion may include a first inclined portion adjacent to the first region and a second inclined portion adjacent to the second region, and the point at which the recessed portion has the minimum thickness may correspond to a point where the first inclined portion meets the second inclined portion.

The window may include a reinforced portion and a non-reinforced portion surrounded by the reinforced portion.

In the third region, the reinforced portion may include a first reinforced portion having a depth of layer (DOL) in a range of 10% to 20% of the first thickness of the first portion of the window and a second reinforced portion having the DOL in a range of 10% to 20% of the second thickness of the second portion of the window.

The electronic device may include a first layer component arranged on an upper side of the window and a second layer component arranged on a lower side of the window, where the display module may include at least one adhesive member, and where a first adhesive member of the at least one adhesive member has a first length from an upper surface of the window to a lower surface of the first layer component in the first region, a second length from the upper surface of the window to the lower surface of the first layer component in the second region, the second length being greater than the first length, and a third length from the upper surface of the window to the lower surface of the first layer component in the third region, the third length being greater than or equal to the second length.

A second adhesive member of the at least one adhesive member may have a fourth length from the lower surface of the window to an upper surface of the second layer component, in the first region, the second region and the third region.

A second adhesive member of the at least one adhesive member may have a fifth length from a lower surface of the window to an upper surface of the second layer component in the first region, a sixth length from the lower surface of the window to the upper surface of the second layer component in the second region, the sixth length being greater than the fifth length, and a seventh length from the lower surface of the window to the upper surface of the second layer component in the third region, the seventh length being greater than or equal to the sixth length.

According to an aspect of the disclosure, an electronic device may include at least one housing, a display module including a first region, a second region and a third region between the first region and the second region, and a window having a first portion having a first thickness in the first region, a second portion having a second thickness in the second region, the second thickness being less than the first thickness, and a recessed portion in the third region, a support plate supporting the display module and having a plurality of slit holes in the second region and the third region, a multi-bar assembly coupled to the display module and configured for sliding-in or sliding-out the display module, and a drive module coupled to the multi-bar assembly, where the display module has a first radius of curvature between the first region and the third region, a second radius of curvature between the second region and the third region, and a third radius of curvature at a point having a minimum thickness in the recessed portion.

### BRIEF DESCRIPTION OF DRAWINGS

The above and other aspects, features, and advantages of certain embodiments of the present disclosure will be more apparent from the following description taken in conjunction with the accompanying drawings, in which:

FIG. 1 is a block diagram illustrating an electronic device in a network environment according to various embodiments;

FIG. 2 is a diagram of a display module according to an embodiment;

FIG. 3A is a view illustrating an unfolded state of a foldable electronic device according to an embodiment;

FIG. 3B is a view illustrating a folded state of a foldable electronic device according to an embodiment;

FIG. 3C is an exploded perspective view of a foldable electronic device according to an embodiment;

FIG. 4 is a diagram illustrating an example of a partial stacking relationship of a foldable electronic device according to an embodiment;

FIGS. 5 to 8 are cross-sectional views respectively illustrating examples a foldable electronic device according to embodiments;

FIG. 9A is a diagram illustrating a slide-in state of a rollable electronic device according to an embodiment;

FIG. 9B is a diagram illustrating a slide-out state of a rollable electronic device according to an embodiment;

FIG. 9C is an exploded perspective view of a rollable electronic device according to an embodiment;

FIGS. 10A and 10B are diagrams respectively illustrating an example of a partial stacking relationship of a rollable electronic device according to an embodiment;

FIGS. 11 to 14 are cross-sectional views respectively illustrating examples of a rollable electronic device according to embodiments;

FIG. 15 is an enlarged view of a recessed portion formed on one surface of a window according to an embodiment;

FIG. 16 is an enlarged view of recessed portions formed on both sides of a window according to an embodiment;

FIGS. 17A and 17B are cross-sectional views illustrating a chemically reinforced window, according to embodiments.

### DETAILED DESCRIPTION

Hereinafter, example embodiments of the disclosure will be described in detail with reference to the accompanying drawings. The same reference numerals are used for the same components in the drawings, and redundant descriptions thereof will be omitted. The embodiments described herein are example embodiments, and thus, the disclosure is not limited thereto and may be realized in various other forms. It is to be understood that singular forms include plural referents unless the context clearly dictates otherwise. The terms including technical or scientific terms used in the disclosure may have the same meanings as generally understood by those skilled in the art.

In the following description, referring to the accompanying drawings, certain examples for implementing the disclosed invention are illustrated as examples in the drawings. Further, other examples may be used and structural changes or modification may be made without departing from the scope of various examples.

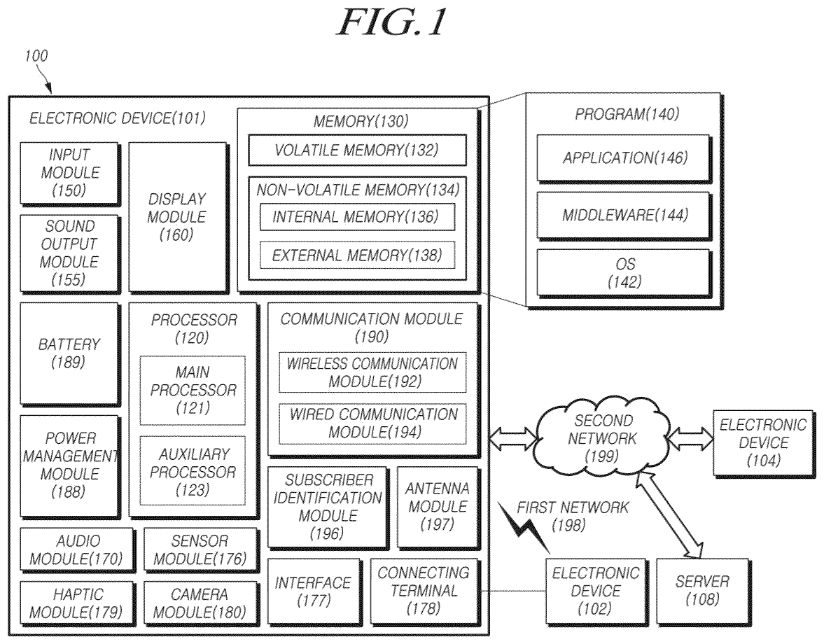

FIG. 1 is a block diagram illustrating an electronic device in a network environment 100 according to various embodiments. Referring to FIG. 1, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one (e.g., the connecting terminal 178) of the components may be omitted from the electronic device 101, or one or more other components may be added in the electronic device 101. According to an embodiment, some (e.g., the sensor module 176, the camera module 180, or the antenna module 197) of the components may be integrated into a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be configured to use lower power than the main processor 121 or to be specified for a designated function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. The artificial intelligence model may be generated via machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by other component (e.g., the processor 120) of the electronic device 101, from the outside (e.g., a user) of the electronic device 101. The input module 150 may include, for example, a microphone, a mouse, a keyboard, keys (e.g., buttons), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display 160 may include, for example, a display, a hologram device, or a projector and control circuitry to control a corresponding one of the display, hologram device, and projector. According to an embodiment, the display 160 may include a touch sensor configured to detect a touch, or a pressure sensor configured to measure the intensity of a force generated by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an accelerometer, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the AP) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via a first network 198 (e.g., a short-range communication network, such as Bluetooth™, Wi-Fi direct, or infrared data association (IrDA)) or a second network 199 (e.g., a long-range communication network, such as a legacy cellular network, a 5G network, a next-generation communication network, the Internet, or a computer network (e.g., local area network (LAN) or wide area network (WAN))). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device). According to an embodiment, the antenna module 197 may include one antenna including a radiator formed of a conductor or conductive pattern formed on a substrate (e.g., a printed circuit board (PCB)). According to an embodiment, the antenna module 197 may include a plurality of antennas (e.g., an antenna array). In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. According to an embodiment, other parts (e.g., radio frequency integrated circuit (RFIC)) than the radiator may be further formed as part of the antenna module 197.

According to various embodiments, the antenna module 197 may form a mmWave antenna module. According to an embodiment, the mmWave antenna module may include a PCB, a RFIC disposed on a first surface (e.g., the bottom surface) of the PCB, or adjacent to the first surface and capable of supporting a designated high-frequency band (e.g., the mmWave band), and a plurality of antennas (e.g., array antennas) disposed on a second surface (e.g., the top or a side surface) of the PCB, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. The external electronic devices 102 or 104 each may be a device of the same or a different type from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an Internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

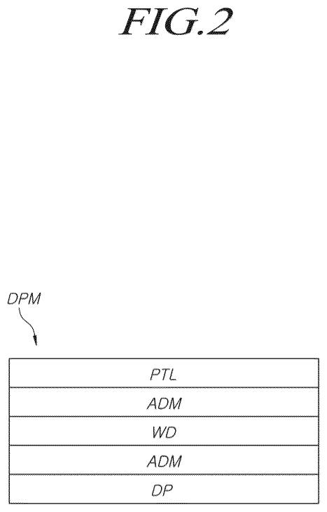

FIG. 2 is a diagram of a display module according to an embodiment.

The electronic device 101 of FIG. 1 according to an embodiment of the disclosure may include one or more display modules DPM. In an embodiment, the display module DPM may include a display panel DP, a window WD, and a protective layer PTL.

According to an embodiment, the display panel DP may include a light emitting device such as an organic light emitting diode (OLED), a liquid crystal display (LCD), or a quantum nano emitting diode (QNED), but is not limited thereto.

According to an embodiment, the window WD may be made of a glass material, a plastic material, or a mixture thereof. That is, the window WD may be formed of a glass member, a plastic member, or a mixture member. According to an embodiment, the glass member may include various glass such as Soda-lime glass, Lead-Alkali glass, Borosilicate glass, Aluminosilicate glass, Silica glass, or the like, but is not limited thereto. When the window is made of a polymer material, the window may be made of poly (methylmetacrylate) (PMMA) and/or polycarbonate (PC), but is not limited thereto. According to an embodiment, the glass member may be used as at least a portion of the display module of the electronic device or as a cover of the display module.

According to an embodiment, the protective layer PTL may include a hard coating layer, an anti-fingerprint coating layer, or a composite layer thereof. According to an embodiment, the protective layer PTL may be formed of a high-modulus material. For example, the protective layer PTL may be flexible to be at least partially folded or bent. According to an embodiment, the protective layer PTL may have chemical resistance and corrosion resistance. The protective layer PTL may include an acrylic compound, an epoxy compound, or an organic/inorganic composite compound, or a combination thereof. Further, the protective layer PTL may include an ultraviolet curable resin other than an acrylic compound and an epoxy compound.

According to an embodiment, the display panel DP, the window WD, and the protective layer PTL may be bonded at least partially or entirely with an adhesive member ADM. The adhesive member ADM may include an optically transparent adhesive film (e.g., an optically clear adhesive (OCA) film) or an optically transparent adhesive resin (e.g., an optically clear resin (OCR)).

A case in which the window WD is made of a glass member will be described as an example, but various embodiments of the disclosure are not limited thereto, and the window WD may be also made of a plastic member as described above.

The display module and the window applied to an embodiment of the disclosure may apply not only to a foldable device but also to a rollable device, and the disclosure is not limited to any one of a plurality of flexible modes. The electronic device according to an embodiment may be realized as a foldable, rollable, or slidable electronic device according to the flexible characteristics of the display module.

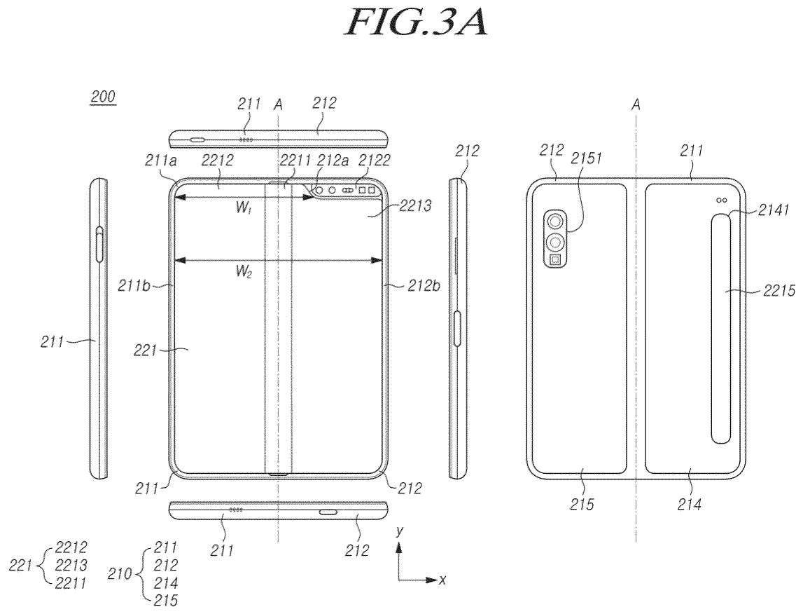

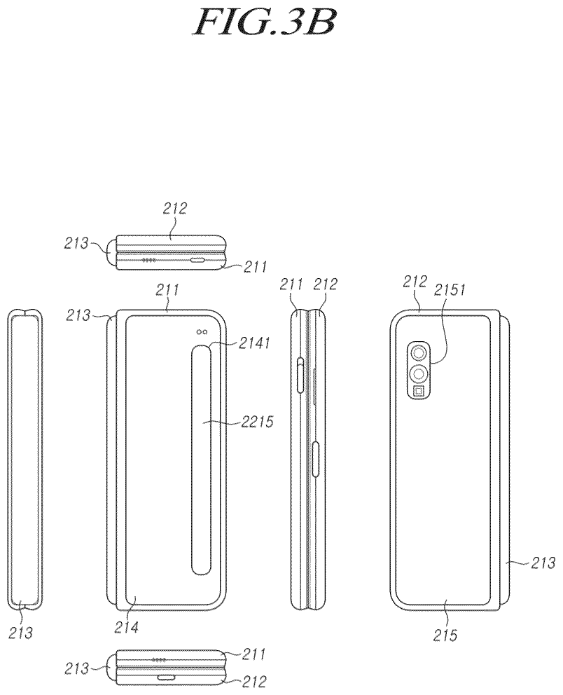

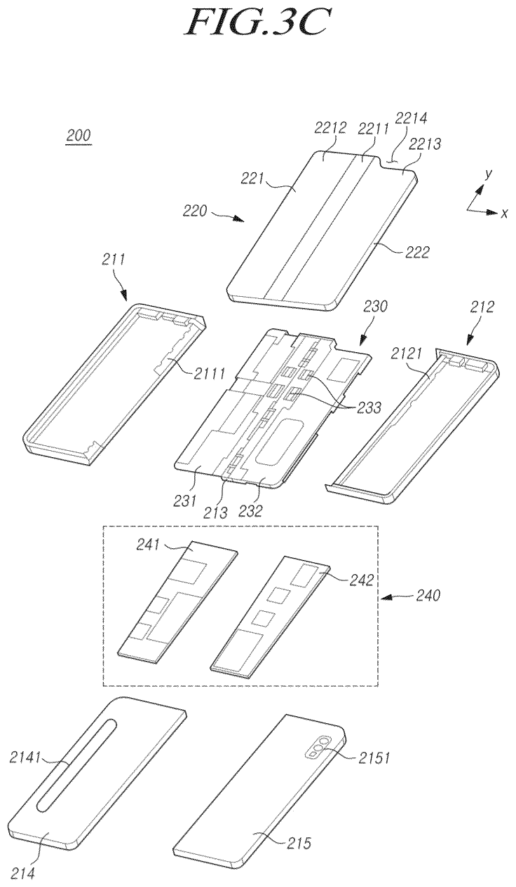

FIGS. 3A and 3B illustrate a foldable electronic device applied to an embodiment of the disclosure.

Referring to FIGS. 3A and 3B, according to an embodiment, the electronic device 200 may include a foldable housing 210, a hinge cover 213 to cover a foldable portion of the foldable housing 210, and a flexible or foldable display 221 disposed in a space formed by the foldable housing 210. Throughout the disclosure, a surface on which the display 221 is disposed is defined as a first surface or a front surface of the electronic device 200. Further, an opposite surface of the front surface is defined as a second surface or a rear surface of the electronic device 200. Further, a surface surrounding a space between the front surface and the rear surface is defined as a third surface or a side surface of the electronic device 200.

According to an embodiment, the foldable housing 210 may include a first housing structure 211, a second housing structure 212 including a sensor area 2122, a first rear cover 214, and a second rear cover 215. The foldable housing 210 of the electronic device 200 is not limited to the shape and the coupling structure illustrated in FIGS. 3A and 3B, and may be implemented by a combination and/or a coupling of other shapes or parts. For example, in another embodiment, the first housing structure 211 and the first rear cover 214 may be integrally formed, and the second housing structure 212 and the second rear cover 215 may be integrally formed.

According to an embodiment, the first housing structure 211 and the second housing structure 212 may be disposed on both sides about a folding axis (e.g., axis A), and may have a substantially symmetrical shape with respect to the folding axis A. As will be described later, an angle or a distance between the first housing structure 211 and the second housing structure 212 may vary depending on whether the electronic device 200 is in an unfolded state, a folded state, or an intermediate state. In an embodiment, unlike the first housing structure 211, the second housing structure 212 may further include the sensor area 2122 in which various sensors are arranged, but they may have a substantially symmetrical shape in other areas. In another embodiment, the sensor area 2122 may be additionally disposed in or replaced with at least a partial area of the first housing structure 211 or the second housing structure 212.

According to an embodiment, the electronic device 200 may be operated in an in-folding manner and/or an out-folding manner by rotation of the first housing structure 211 with respect to the second housing structure 212 in a range of 0 to 360 degrees with a hinge structure (not shown). According to various embodiments, the hinge structure may be formed in a vertical direction or a horizontal direction when the electronic device 200 is viewed from above. According to various embodiments, the electronic device may have a plurality of hinge structures. For example, the plurality of hinge structures may be all arranged in the same direction. As another example, some hinge structures among the plurality of hinge structures may be arranged in a different direction and folded.

According to an embodiment, as shown in FIG. 3A, the first housing structure 211 and the second housing structure 212 may together form a recess for accommodating the display 221. According to an embodiment, due to the sensor area 2122, the recess may have two or more different widths in a direction perpendicular to the folding axis A.

For example, the recess may have a first width w1 between a first portion 211a parallel to the folding axis A of the first housing structure 211 and a first portion 213A formed in an edge of the sensor area 2122 of the second housing structure 212, and a second width w2 between a second portion 211b of the first housing structure 211 and a second portion 213B that is parallel to the folding axis A and does not belong to the sensor area 2122 of the second housing structure 212. In this case, the second width w2 may be formed to be longer than the first width w1. In other words, the first portion 211a of the first housing structure 211 and the first portion 213A of the second housing structure 212 having an asymmetric shape to each other may form the first width w1 of the recess, and the second portion 211b of the first housing structure 211 and the second portion 213B of the second housing structure 212 having a substantially symmetrical shape to each other may form the second width w2 of the recess. According to an embodiment, the first portion 213A and the second portion 213B of the second housing structure 212 may have different distances from the folding axis A. The width of the recess is not limited to the illustrated example. According to various embodiments, the recess can have multiple widths owing to the shape of the sensor area 2122 or the portion having the asymmetric shape of the first housing structure 211 and the second housing structure 212.

According to an embodiment, at least a portion of the first housing structure 211 and the second housing structure 212 may be formed of a metallic material or a non-metallic material having a designated amount of rigidity to support the display 221.

According to an embodiment, the sensor area 2122 may be formed to have a predetermined area adjacent to one corner of the second housing structure 212. However, the arrangement, the shape, and the size of the sensor area 2122 are not limited to the illustrated example. For example, in other embodiments, the sensor area 2122 may be provided at another corner of the second housing structure 212 or any area between the top and bottom corners. According to an embodiment, components for performing various functions embedded in the electronic device 200 may be exposed onto a front surface of the electronic device 200, through the sensor area 2122 or through one or more openings provided in the sensor area 2122. According to various embodiments, the components may include various types of sensors. The sensor may include, for example, at least one of a front camera, a receiver or a proximity sensor, an illuminance sensor, an iris recognition sensor, an ultrasonic sensor, or an indicator.

According to an embodiment, the first rear cover 214 may be disposed on one side of a folding shaft on the rear surface of the electronic device, and may have, for example, a substantially rectangular periphery, the periphery being covered with the first housing structure 211. Similarly, the second rear cover 215 may be disposed on the other side of the folding axis of the rear surface of the electronic device, of which periphery may be covered with the second housing structure 212.

According to an embodiment, the first rear cover 214 and the second rear cover 215 may have a substantially symmetrical shape with respect the folding axis (e.g., axis A). However, the first rear cover 214 and the second rear cover 215 do not necessarily have the symmetrical shape, and in another embodiment, the electronic device 200 may have various shapes of the first rear cover 214 and the second rear cover 215. In another embodiment, the first rear cover 214 may be integrally formed with the first housing structure 211, and the second rear cover 215 may be integrally formed with the second housing structure 212.

According to an embodiment, the first rear cover 214, the second rear cover 215, the first housing structure 211, and the second housing structure 212 may form an internal space in which various components of the electronic device 200 (e.g., a PCB, or a battery) may be arranged. According to an embodiment, one or more components may be disposed or visibly exposed on the rear surface of the electronic device 200. For example, at least a portion of a sub-display 2215 may be visually exposed through a first rear area 2141 of the first rear cover 214. In another embodiment, one or more components or sensors may be visually exposed through a second rear area 2151 of the second rear cover 215. According to various embodiments, the sensor may include a proximity sensor and/or a rear camera.

Referring to FIG. 3B, the hinge cover 213 may be disposed between the first housing structure 211 and the second housing structure 212 to cover internal components (e.g., a hinge structure). According to an embodiment, the hinge cover 213 may be covered with a portion of the first housing structure 211 and the second housing structure 212 or may be exposed to the outside, according to a state of the electronic device 200 (a flat state or a folded state).

For example, as shown in FIG. 3A, when the electronic device 200 is in an unfolded state, the hinge cover 213 may not be exposed to the outside as it is covered with the first housing structure 211 and the second housing structure 212. For example, as shown in FIG. 3B, when the electronic device 200 is in a folded state (e.g., a fully folded state), the hinge cover 213 may be exposed to the outside between the first housing structure 211 and the second housing structure 212. For example, when the first housing structure 211 and the second housing structure 212 are in an intermediate state that they are folded with a certain angle, the hinge cover 213 may be partially exposed to the outside between the first housing structure 211 and the second housing structure 212. However, in this case, the exposed area may be smaller than in the fully folded state. According to an embodiment, the hinge cover 213 may include a curved surface.

The display 221 may be disposed on a space formed by the foldable housing 210. For example, the display 221 may be seated on a recess formed by the foldable housing 210 and may make up most of the front surface of the electronic device 200.

Accordingly, the front surface of the electronic device 200 may include the display 221, a partial area of the first housing structure 211 adjacent to the display 221, and a partial area of the second housing structure 212. Further, the rear surface of the electronic device 200 may include a first rear cover 214, a partial area of the first housing structure 211 adjacent to the first rear cover 214, a second rear cover 215, and a partial area of the second housing structure 212 adjacent to the second rear cover 215.

The display 221 may refer to a display in which at least a portion of its display area may be transformed into a flat surface or a curved surface. According to an embodiment, the display 221 may include a folding area 2211, a first area 2212 disposed on one side with respect to the folding area 2211 (e.g., a left side of the folding area 2211 shown in FIG. 3A), and a second area 2213 disposed on the other side (e.g., a right side of the folding area 2211 shown in FIG. 3A).

The regional division of the display 221 shown in FIG. 3A is only of an example, and the display 221 may be divided into a plurality of areas (e.g., two or four or more areas) according to its structure or function. For example, as shown in FIG. 3A, the area of the display 221 may be divided by the folding area 2211 extending parallel to Y-axis or the folding axis (e.g., axis A), or may be divided on the basis of another folding area (e.g., the folding area parallel to X-axis) or another folding axis (e.g., the folding axis parallel to X-axis).

The first area 2212 and the second area 2213 may have a substantially symmetrical shape with respect to the folding area 2211. However, unlike the first area 2212, the second area 2213 may additionally have a notch (e.g., 2214 in FIG. 3C) cut according to the presence of the sensor area 2122, but in other area it may have a substantially symmetrical shape with respect to the first area 2212. In other words, the first area 2212 and the second area 2213 may include a portion having a shape symmetrical to each other and a portion having a shape asymmetric to each other.

Hereinafter, description will be made of the operation of the first housing structure 211 and the second housing structure 212 according to the state of the electronic device 200 (e.g., a flat state and a folded state), and each area of the display 221.

According to an embodiment, when the electronic device 200 is in a flat state (e.g., in FIG. 3A), the first housing structure 211 and the second housing structure 212 may form an angle of substantially 180 degrees and may be arranged to face the same direction. A surface of the first area 2212 and a surface of the second area 2213 of the display 221 may form substantially 180 degrees with each other to face the same direction (e.g., the front direction of the electronic device). The folding area 2211 may form the same plane as the first area 2212 and the second area 2213.

According to an embodiment, when the electronic device 200 is in a folded state (e.g., in FIG. 3B), the first housing structure 211 and the second housing structure 212 may be disposed to face each other. The surface of the first area 2212 and the surface of the second area 2213 of the display 221 may be arranged to face each other, forming a narrow angle (e.g., between 0 to 10 degrees). At least a portion of the folding area 2211 may be formed of a curved surface having a predetermined curvature.

According to an embodiment, when the electronic device 200 is in a folded state (e.g., in FIG. 3B), the first housing structure 211 and the second housing structure 212 may be arranged with at a certain angle. The surface of the first area 2212 and the surface of the second area 2213 of the display 221 may form an angle greater than that of the folded state and smaller than that of the unfolded state. At least a portion of the folding area 2211 may be formed of a curved surface having a predetermined curvature, and the curvature in this case may be smaller than that in a folded state.

FIG. 3C is an exploded perspective view of an electronic device according to an embodiment of the disclosure.

Referring to FIG. 3C, according to an embodiment, the electronic device 200 may include a display unit 220, a bracket assembly 230, a substrate 240, a first housing structure 211, a second housing structure 212, a first rear cover 214, and a second rear cover 215. Throughout the disclosure, the display unit 220 may be referred to as a display module or a display assembly.

The display unit 220 may include a display 221 and one or more plates 222 or layers on which the display 221 is seated. According to an embodiment, the plate 222 may be disposed between the display 221 and the bracket assembly 230. The display 221 may be disposed on at least a portion of one surface of the plate 222 (e.g., an upper surface with respect to FIG. 3C). The plate 222 may be formed in a shape corresponding to the display 221. For example, a portion of the plate 222 may be formed in a shape corresponding to the notch 2214 of the display 221.

The bracket assembly 230 may include a first bracket 231, a second bracket 232, a hinge structure (not shown) disposed between the first bracket 231 and the second bracket 232, a hinge cover 213 that covers when the hinge structure is viewed from the outside, and a wiring member 233 (e.g., a flexible PCB (FPCB)) crossing the first bracket 231 and the second bracket 232.

According to an embodiment, between the plate 222 and the substrate 240 may be disposed the bracket assembly 230. For example, the first bracket 231 may be disposed between the first area 2212 of the display 221 and the first substrate 241. The second bracket 232 may be disposed between the second area 2213 of the display 221 and the second substrate 242.

According to an embodiment, at least a portion of the wiring member 233 and the hinge structure may be disposed inside the bracket assembly 230. The wiring member 233 may be disposed in a direction (e.g., X-axis direction) crossing the first bracket 231 and the second bracket 232. The wiring member 233 may be disposed in a direction (e.g., X-axis direction) perpendicular to the folding axis (e.g., Y-axis or the folding axis A of FIG. 3A) of the folding area 2211 of the electronic device 200.

As mentioned above, the substrate 240 may include a first substrate 241 disposed on the first bracket 231 side and the second substrate 242 disposed on the second bracket 232 side. The first substrate 241 and the second substrate 242 may be disposed inside a space formed by the bracket assembly 230, the first housing structure 211, the second housing structure 212, the first rear cover 214, and the second rear cover 215. Components for implementing various functions of the electronic device 200 may be mounted on the first substrate 241 and the second substrate 242.

The first housing structure 211 and the second housing structure 212 may be assembled to each other so as to be coupled to both sides of the bracket assembly 230, in a state in which the display unit 220 is coupled to the bracket assembly 230. As will be described later, the first housing structure 211 and the second housing structure 212 may be coupled to the bracket assembly 230, sliding from both sides of the bracket assembly 230.

According to an embodiment, the first housing structure 211 may include a first rotation support surface 2111, and the second housing structure 212 may include a second rotation support surface 2121 corresponding to the first rotation support surface 2111. The first rotation support surface 2111 and the second rotation support surface 2121 may include a curved surface corresponding to the curved surface included in the hinge cover 213.

According to an embodiment, when the electronic device 200 is in an unfolded state (e.g., the electronic device of FIG. 3A), the first rotational support surface 2111 and the second rotational support surface 2121 may cover the hinge cover 213 so that the hinge cover 213 is not exposed to the rear surface of the electronic device 200 or may be minimally exposed. Meanwhile, when the electronic device 200 is in a folded state (e.g., the electronic device of FIG. 3B), the first rotation support surface 2111 and the second rotation support surface 2121 may rotate along a curved surface included in the hinge cover 213 so that the hinge cover 213 may be maximally exposed to the rear surface of the electronic device 200.

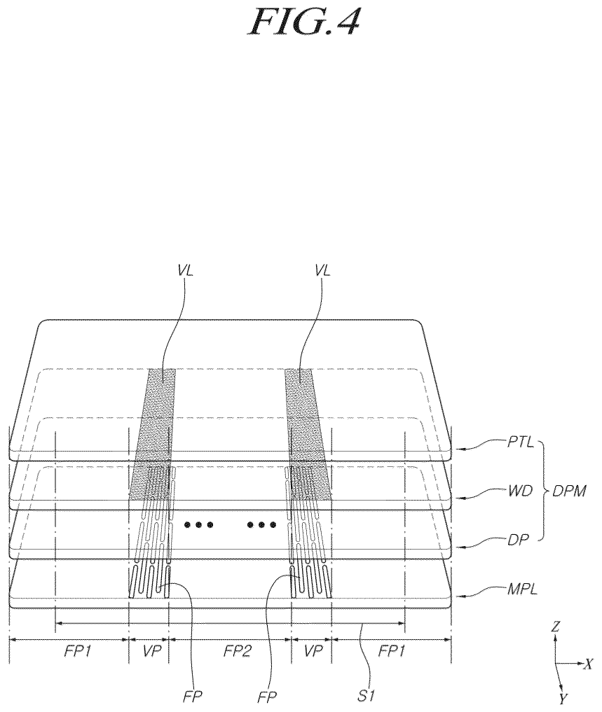

FIG. 4 is a diagram illustrating an example of a partial stacking relationship of a foldable electronic device according to an embodiment.

Referring to FIG. 4, in an embodiment, the electronic device may include a display module DPM and a support plate MPL. A protective layer PTL may be provided on a front surface of the display module DPM, and a display panel DP may be provided on a rear surface thereof, but the disclosure is not limited thereto. Various components may be arranged between the protective layer PTL and the display panel DP. For example, a window WD may be provided between the protective layer PTL and the display panel DP. At least some of the respective layer components constituting the display module DPM may be bonded by an adhesive member.

According to an embodiment, the window WD may have different thicknesses for each region. In an embodiment, the window WD may be divided into a thick portion region FP1, a thin portion region FP2, and a recessed portion region VP, and may have different thicknesses in each region. In the thick portion region FP1, the thin portion region FP2, and the recessed portion region VP may be positioned the window WD having a thin portion, a thick portion, and a recessed portion VL, respectively.

According to an embodiment, the window WD may include a thick portion having a first thickness and a thin portion having a second thickness. In an embodiment, the thick portion may be formed to be thicker than the thin portion (i.e., first thickness>second thickness). Accordingly, the thin portion region FP2 of the display module DPM may have folding characteristics. The display module DPM may be bent using the thin portion region FP2, thereby implementing a foldable electronic device.

According to an embodiment, a recessed portion VL may be formed between the thick portion and the thin portion. The recessed portion VL may be connected between the thick portion and the thin portion while forming a variable thickness. In an embodiment, the recessed portion VL has substantially the same thickness as that of the thick portion at its one end and may be continuously connect to the thick portion. In an embodiment, the recessed portion VL has substantially the same thickness as that of the thin portion at its other end and may be continuously connected to the thin portion. Accordingly, the recessed portion VL may be connected to the thick portion without forming a step. Further, the recessed portion VL may be seamlessly connected to the thin portion without forming a step.

In an embodiment, a support plate MPL may be coupled to a rear surface of the display panel DP. In an embodiment, the support plate MPL may include a plurality of folding patterns FP, and the support plate MPL may be bent in one region where the folding patterns FP are provided. In an embodiment, the folding patterns FP on the support plate MPL may be formed over a region corresponding to the thin portion region FP2 and the recessed portion region VP. For example, the folding patterns FP may be formed over the entire thin portion region FP2. For example, the folding patterns FP may be formed over the entire or partial area of the recessed portion region VP. For example, the support plate MPL may include metal.

According to an embodiment, the window WD may include two or more recessed portions VL. In an embodiment, the recessed portion VLs may be formed to extend in a folding direction (e.g., X-axis direction) and a vertical direction (e.g., Y-axis direction). In an embodiment, the two or more recessed portions VL may be formed parallel to each other. In an embodiment, the two or more recessed portions VL may be formed to be spaced apart from each other.

According to an embodiment, when two or more recessed portions VL are formed in the window WD, the folding pattern FP of the support plate MPL may be formed over the recessed portion regions VPs and the thin portion region FP2 located therebetween. In an embodiment, the folding pattern FP may be formed not only over the recessed portion regions VP and the thin portion region FP2, but also over a partial region of the thick portion region FP1 adjacent to the recessed portion region VP.

According to an embodiment, the window WD may have a single recessed portion VL and at least one thick portion, and may not include any thin portion. The single recessed portion VL may be positioned between two or more thick portions. The minimum thickness of the recessed portion VL may be formed with a sufficiently thin thickness to realize the folding characteristics. The display module DPM having the window WD without any thin portion may be folded only using such a single recessed portion VL. In an embodiment, the folding pattern FP of the support plate MPL may be formed over the recessed portion region VP corresponding to the single recessed portion VL, but is not limited thereto, and it may be also formed partially in at least a part of the thick portion region FP1 adjacent to the recessed portion region VP.

According to an embodiment, the window WD may have all of a single recessed portion VL, a thin portion, and a thick portion. The single recessed portion VL may be positioned between the thin portion and the thick portion. The minimum thickness of the recessed portion VL may have a thickness less than that of the thin portion so as to realize the folding characteristics. The display module DPM having the single recessed portion VL may be folded using (i) a single recessed portion VL, or using (ii) a single recessed portion VL and at least a part of a thin portion adjacent thereto. In an embodiment, the folding pattern FP of the support plate MPL may be formed over the recessed portion region VP corresponding to the single recessed portion VL, but is not limited thereto, and the folding pattern FP of the support plate MPL may be also formed partially in at least a part of the thin portion region FP2 adjacent to the recessed portion region VP. Furthermore, in an embodiment, the folding pattern FP may be also formed at least partially in the thick portion region FP1 adjacent to the recessed portion region VP.

Hereinafter, cross-sections of the display module DPM and the support plate MPL corresponding to a portion S1 of FIG. 4 are shown.

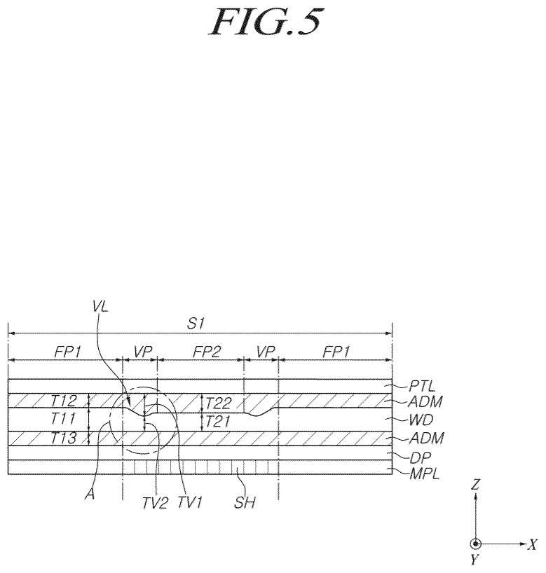

FIGS. 5 to 8 are cross-sectional views respectively illustrating examples a foldable electronic device according to embodiments.

FIG. 5 is a cross-sectional view of a foldable display module having a window with a recessed portion formed on one surface thereof.

Referring to FIG. 5, the display module may include or may be divided into a first region (e.g., thick portion region, FP1) formed with a first thickness T11, a second region (e.g., thin portion region, FP2) formed with a second thickness T21 that is smaller than the first thickness T11, and a third region(s) (e.g., recessed portion region, VP) formed between the first region FP1 and the second region FP2. In an embodiment, the third region VP may include at least two regions of the window WD. In an embodiment, the second region FP2 may be located at a central portion of the window WD, and the first region FP1 may include a region extending from a periphery of the second region FP2 to an edge of the window WD.

In an embodiment, the window WD may have substantially the same thickness T11 over the first region FP1. In an embodiment, the window WD may have substantially the same thickness T21 over the second region FP2. In an embodiment, in the third region VP, a recessed portion VL may be formed on one surface of the window WD. The recessed portion VL may be formed to be concave downwards along the vertical direction of the display module (e.g., the DPM of FIG. 2).

In an embodiment, the window WD may have a first thickness T11 in the first region FP1 and a second thickness T21 in the second region FP2. In an embodiment, the window WD may have a third thickness TV2 in the third region VP.

In an embodiment, the first thickness T11 may be formed to be greater than or equal to the second thickness T21. In an embodiment, as the first thickness T11 is formed to be greater than the second thickness T21, the window WD may remain flat in the first region FP1 and may be bent by an external force in the second region FP2. In an embodiment, as the window WD is bent in the second region FP2, the window WD may be folded so that two first regions FP1 face each other with respect to the second region FP2. Such a thinly formed second region FP2 may realize a foldable display module.

In an embodiment, the display module may be divided, although embodiments are not limited thereto, into two or more first regions FP1 and a third region VP without any second region FP2. In this case, the display module may be bent by the third region VP, and the window WD may be folded so that the first regions FP1 face each other by the third region VP.

In an embodiment, the thickness (e.g., third thickness, TV2) of the recessed portion VL formed in the third region VP may be formed to vary as it moves from the first region FP1 to the second region FP2. In an embodiment, the third thickness TV2 may have a maximum thickness at a point contacting the first region FP1.

In an embodiment, the third thickness TV2 may have a minimum thickness at one point in the center of the third region VP. In an embodiment, the third thickness TV2 may become thicker as it goes from the center of the third region VP toward a point contacting the first region FP1 or the second region FP2.

In an embodiment, the third thickness TV2 may be formed to have the same thickness as the first thickness T11 at a point where the third region VP is contacting the first region FP1. In an embodiment, the third thickness TV2 may be formed to have the same thickness as the second thickness T21 at a point where the third region VP is contacting the second region FP2.

In an embodiment, the first thickness T11, that is, the thickness of the thick portion, may have a length of 40 μm to 500 μm. In an embodiment, the second thickness T21, that is, the thickness of the thin portion, may have a length of 10 μm to 80 μm.

In an embodiment, a recessed portion VL may be formed on one surface of the window WD, and a recessed portion VL may not be formed on the other surface opposite to one surface of the window WD. In other words, an opposite surface facing the surface on which the recessed portion VL is formed may be formed to be flat.

In an embodiment, the foldable display module may be foldable using the second region FP2 and the third region VP, and the first region FP1 may be maintained in a flat state while being folded or unfolded by the second region FP2 and the third region VP.

In an embodiment, the display module may further include an adhesive member ADM bonding other layer components. The layer components may include, for example, a protective layer, a display panel, or another functional layer. In an embodiment, the layer components may be classified based on their positional relationship with the window WD. For example, a component that is arranged on an upper side of the window WD may be classified into a first layer component (e.g., a protective layer, PTL) and a component that is arranged on a lower side of the window WD may be classified into a second layer component (e.g., a display panel, DP).

In an embodiment, the adhesive member ADM may bond between the first layer component and the window WD and between the second layer component and the window WD.

In an embodiment, the adhesive member ADM bonding the window WD and the first layer component may have the same thickness or different thicknesses for each of the first to third regions FP1, FP2, and VP.

In an embodiment, the adhesive member ADM may be positioned on both surfaces or at least one surface of the window WD. For example, the adhesive member ADM may be formed on a front surface of the window WD. For example, the adhesive member ADM may be formed on both the front surface and the rear surface of the window WD.

In an embodiment, the adhesive members ADM may be arranged so that the upper side of the window WD is flattened. For example, the adhesive member ADM may be formed to have different thicknesses in the first region FP1, the second region FP2, and the third region VP. In an embodiment, the sum of the thicknesses of the adhesive member ADM and the window WD may be uniformly formed over the entire region. For example, the sum of thickness T12 and thickness T11 in the first region FP1, the sum of thickness T22 and thickness T21 in the second region FP2, and the sum of thickness TV1 and thickness TV2 in the third region VP may all be substantially the same.

Specifically, the adhesive member ADM has a first length T12 from the front surface of the window WD to the rear surface of the first layer component in the first region FP1, a second length T22 from the front surface of the window WD to the rear surface of the first layer component in the second region FP2, and a third length TV1 from the front surface of the window WD to the rear surface of the first layer component in the third region VP. In this case, the second length T22 may be greater than or equal to the first length T12, and the third length TV1 may be greater than the second length T22 at a maximum and equal to the first length T12 at a minimum.

In an embodiment, the adhesive member ADM disposed underneath the window portion may be formed to have the same thickness over the first to third regions (FP1, FP2, VP). As the rear surface of the window WD and the front surface of the second layer component (e.g., the display panel DP) bonded to the window WD are formed parallel to each other, the adhesive member ADM may be maintained with the same thickness between the window WD and the second layer component. In an embodiment, the adhesive member ADM bonding the window WD and the second layer component may be formed to have a fourth length T13 from the rear surface of the window WD to the front surface of the second layer component in the first to third regions (FP1, FP2, VP). The fourth length T13 may be equal to or different from either one of the first length T12 or the second length T22.

As such, the window WD according to an embodiment of the disclosure has a recess VL formed in the third region VP, and therefore, a force exerted by the window WD onto the adhesive member ADM during repeated folding operations may be transmitted in a vertical direction rather than a horizontal direction. When the window WD is repeatedly folded, the force may be generally transmitted from the window WD to the adhesive member ADM. In case where this force is repeatedly transmitted in the horizontal direction, the adhesive member ADM may delaminate from the window WD. According to an embodiment, due to the recessed portion VL formed in the window WD, the force caused in the folding operation may be transmitted in the vertical direction rather than the horizontal direction, and thus, the delamination between the adhesive member ADM and the window WD may be minimized.

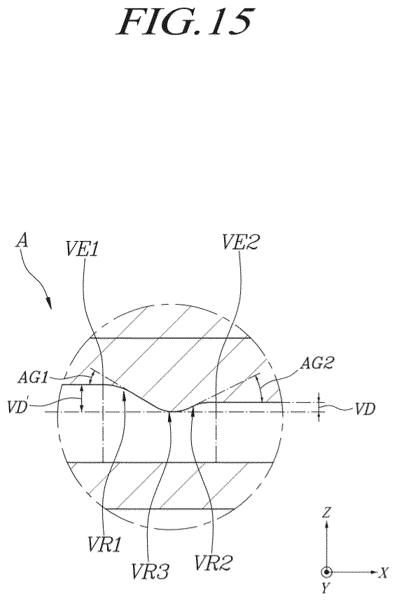

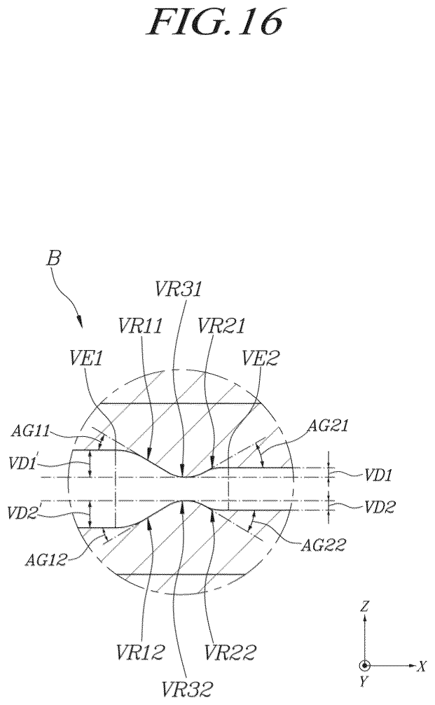

Further, the window WD applied to an embodiment adopts a structure that connects the first region FP1, the second region FP2, and the third region VP with a gentle curved surface, so a boundary between the first region FP1 and the third region VP and a boundary between the second region FP2 and the third region VP may not be visually recognized. For example, a thin portion may be formed in one area of a window substrate through a masking process and an etching process, in which case a step difference between the thin portion and the thick portion may be easily visible even after a polishing process. The window according to an embodiment of the disclosure may form a recessed portion having radiuses of curvature to be described later with reference to FIGS. 15 and 16 through a spray etching process.

In an embodiment, the adhesive member ADM may be made of a material having substantially the same optical characteristics as those of the window WD. The adhesive member ADM may be made of, for example, a polymer material having the same or corresponding light refractive index as that of the window WD. As the window WD and the adhesive member ADM have the same or corresponding light refractive index, the optical refractive properties may not deteriorate even if the boundary between the window WD and the adhesive member ADM is formed in a complicated manner.

In an embodiment, a support plate MPL may be disposed underneath the display module. In an embodiment, slit holes SH for forming the folding pattern (e.g., FP of FIG. 4) may be formed in the support plate MPL. In an embodiment, the slit holes SH may be formed over the second region FP2 and the third region VP. In an embodiment, the slit holes SH may be additionally formed over at least a portion of the first region FP1 adjacent to the third region VP.

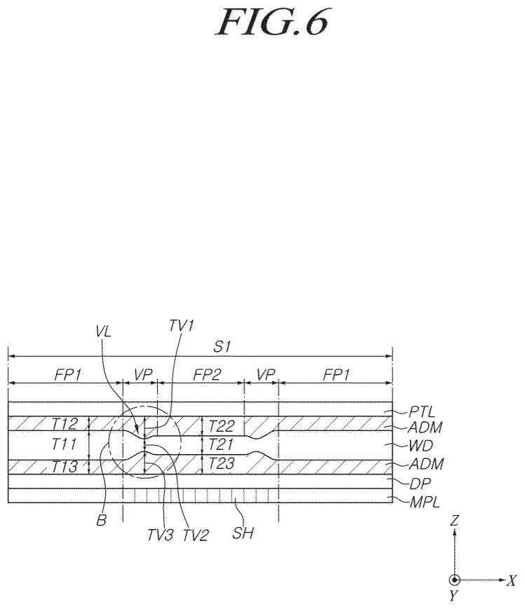

FIG. 6 is a cross-sectional view of a foldable display module having a window with a recessed portion formed on both sides.

Referring to FIG. 6, in an embodiment, recessed portions VL may be formed on both sides of the window WD. The description of the overlapping portions with FIG. 5 will be omitted, and will focus on the structural differences.

In an embodiment, the display module may include or be divided into at least two first regions FP1, a second region FP2 surrounded by the first region FP1, and a third region VP located between the first region FP1 and the second region FP2.

In an embodiment, the window WD (i.e., thick portion) of the first region FP1 may be formed to have a first thickness T11. In an embodiment, the window WD (i.e., thin portion) of the second region FP2 may be formed to have a second thickness T21.

In an embodiment, the first thickness T11 may be formed to be thicker than the second thickness T21. In an embodiment, the second thickness T21 may be formed thin enough to be bent. For example, the thick portion may have a thickness of 40 μm to 500 μm as the first thickness T11, and the thin portion may have a thickness of 10 μm to 80 μm as the second thickness T21. Accordingly, the display module may be bent in the second region FP2 and kept flat in the first region FP1, thereby realizing a foldable operation.

In an embodiment, the recessed portions VL may be formed on both sides of the window WD. In an embodiment, the recessed portion formed on the front surface of the window WD may be referred to as a front recessed portion, and the recessed portion formed on the rear surface thereof may be referred to as a rear recessed portion. The front recessed portion and the rear recessed portion may be formed symmetrically with respect to each other, but the disclosure is not limited thereto. In an embodiment, the recessed portion VL may be formed in the third region VP. In an embodiment, the thickness TV2 of the recessed portion VL may be formed such that it becomes progressively thinner from the first region FP1 to one point and progressively thicker from the one point towards the second region FP2. In an embodiment, the recessed portion VL may have a maximum thickness at a boundary between the first region FP1 and the third region VP. In an embodiment, the recessed portion VL may have a minimum thickness at the one point where the thickness change is changed from negative to positive.

In an embodiment, the recessed portion VL may have the same thickness as that of the first region FP1 at a point contacting the first region FP1. In an embodiment, the recessed portion VL may have the same thickness as that of the second region FP2 at another point contacting the second region FP2.

In an embodiment, the recessed portion VL may be formed on both surfaces of the window WD, and then, the adhesive members ADM arranged on the front surface and the rear surface of the window may have the thickness that changes corresponding to a change in thickness of the recessed portion VL. In an embodiment, the thickness (TV1, TV3) of the adhesive member ADM corresponding to the third region VP respectively arranged on the front and rear surfaces of the window WD may be formed to be progressively thicker from the first region FP1 to one point of the third region VP, and to be progressively thinner from the one point to the second region FP2.

In an embodiment, the adhesive member ADM bonding the front surface of the window WD and the first layer component may be formed to have a thickness TV1 that is changed according to a change in thickness of the window WD in the third region VP. The adhesive member ADM bonding the window WD and the first layer component may have a thickness T12 in the first region FP1, a thickness T22 in the second region FP2, and a thickness TV1 in the third region VP. In an embodiment, T22 may be greater than or equal to T12. In an embodiment, the maximum value of TV1 may be greater than T22, and the minimum value of TV1 may be equal to T12.

In an embodiment, the adhesive member ADM bonding the rear surface of the window WD and the second layer component may have a thickness T13 in the first region FP1, a thickness T23 in the second region FP2, and a thickness TV3 in the third region VP. In an embodiment, T23 may be greater than or equal to T13. In an embodiment, the maximum value of TV3 may be greater than T23, and the minimum value may be equal to T13.

In an embodiment, the window WD may have different thicknesses for each region. For example, the window WD may have a thickness T11 in the first region FP1, a thickness T21 in the second region FP2, and a thickness TV2 in the third region VP. In an embodiment, T11 may be greater than or equal to T21. In an embodiment, the maximum value of TV2 may be equal to T11, and the minimum value may be less than T21.

In an embodiment, the first layer component (e.g., PTL) and the second layer components (e.g., DP) respectively bonded by the adhesive member ADM to the window WD may be provided in a flat shape. As will be described later, such a structure in which the recessed portion is formed on both sides thereof may minimize distortion in shape due to compressive stress or expansion stress during chemical reinforcement.

In an embodiment, a support plate MPL may be disposed underneath the display module. In an embodiment, slit holes SH for forming folding patterns (e.g., FP of FIG. 4) may be formed in the support plate MPL. In an embodiment, the slit holes SH may be formed over the second region FP2 and the third region VP. In an embodiment, the slit holes SH may be further formed over at least a portion of the first region FP1 adjacent to the third region VP.

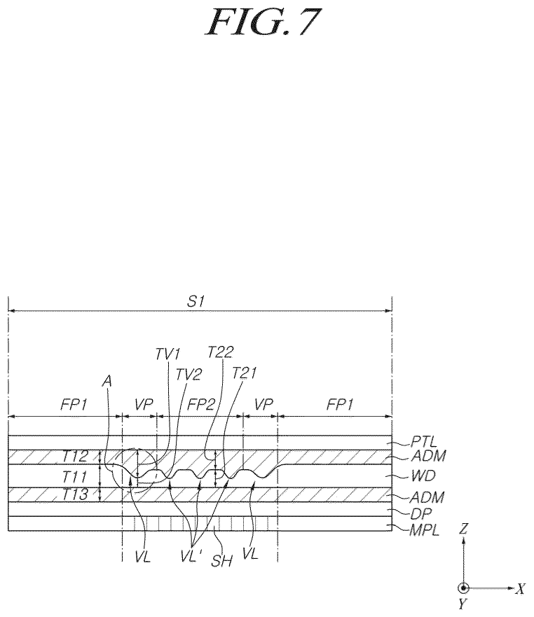

FIG. 7 is a cross-sectional view of a foldable display module having a window in which a plurality of recessed portions are formed.

Referring to FIG. 7, in an embodiment, two or more edge recessed portions VL adjacent to the first region FP1 may be formed on one surface of the window WD (e.g., the front surface or the rear surface), and a plurality of repetitive recessed portion VL′ may be formed in between the two or more edge recessed portions VL. Here, it may be understood that the edge recessed portion VL corresponds to the recessed portion VL shown in FIG. 5. Further, as the display module shown in FIG. 7 has a different structure of the second region FP2 compared to the display module shown in FIG. 5, description will be made focusing on this different structure.

In an embodiment, the window WD may include a plurality of repetitive recessed portions VL′ over the second region FP2 and an edge recessed portion VL over the third region VP. In an embodiment, the edge recessed portion VL may have the same shape as the repetitive recessed portion VL′. In an embodiment, the edge recessed portion VL may have a shape different from that of the repetitive recessed portion VL′.

In an embodiment, the edge recessed portion VL may have a thickness TV2, and the repetitive recessed portion VL′ may have a thickness T21. In an embodiment, the minimum value of the thickness TV2 may be the same as the minimum value of T21. In an embodiment, the maximum value of the thickness TV2 may be the same as the thickness T11. In an embodiment, the thickness TV2 may have the same value as the thickness T21 at a contact point between the edge recessed portion VL and the repetitive recessed portion VL′. In an embodiment, the maximum value of the thickness T21 may be less than the thickness T11.

As the thickness T21 varies over the second region FP2, the thickness T22 of the adhesive member ADM contacting one surface of the repetitive recessed portion VL′ may be reduced or increased to correspond to the change in the thickness T21.

In an embodiment, the adhesive member ADM contacting the rear surface of the window WD may have the same thickness T13 over the first to third regions (FP1, FP2, VP).

In an embodiment, a support plate MPL may be arranged underneath the display module. In an embodiment, slit holes SH for forming the folding pattern (e.g., FP of FIG. 4) may be formed in the support plate MPL. In an embodiment, the slit holes SH may be formed over the second region FP2 and the third region VP. In an embodiment, the slit holes SH may be additionally formed over at least a portion of the first region FP1 adjacent to the third region VP.

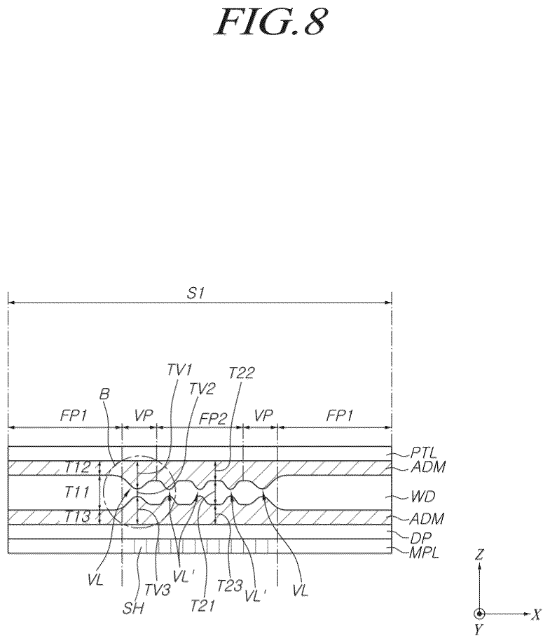

FIG. 8 is a cross-sectional view of a foldable display module having a window with a plurality of recessed portions being formed on both surfaces.

Referring to FIG. 8, in an embodiment, on both surfaces of the window WD may be formed two or more edge recessed portions VL and a plurality of repetitive recessed portions VL′ positioned between the edge recessed portions VL. Here, it is to be understood that the edge recessed portion VL corresponds to the recessed portion VL of FIG. 6. Furthermore, as the display module shown in FIG. 8 has a different structure of the second region FP2 compared to the display module shown in FIG. 6, the description will be mainly made of this structure.

In an embodiment, the window WD may include a plurality of repetitive recessed portions VL′ over the second region FP2 and an edge recessed portion VL over the third region VP. In an embodiment, the edge recessed portion VL may have the same shape as that of the repetitive recessed portion VL′. In an embodiment, the edge recessed portion VL may have a shape different from that of the repetitive recessed portion VL′. In an embodiment, the edge recessed portions VL and the repetitive recessed portions VL′ may be formed on both surfaces of the window.

In an embodiment, the edge recessed portion VL may have a thickness TV2, and the repetitive recessed portion VL′ may have a thickness T21. In an embodiment, the minimum value of the thickness TV2 may be the same as the minimum value of the thickness T21. In an embodiment, the maximum value of the thickness TV2 may be the same as the thickness T11. In an embodiment, the thickness TV2 may have the same value as the thickness T21 at a contact point between the edge recessed portion VL and the repetitive recessed portion VL′. In an embodiment, the maximum value of the thickness T21 may be less than the thickness T11.

As the thickness T21 varies over the second region FP2, the thickness T22 of the adhesive member ADM where the adhesive member ADM contacts the front surface of the repetitive recessed portion VL′ may be reduced or increased to correspond to the change in the thickness T21. Further, as the thickness T21 varies over the second region FP2, the thickness T23 of the adhesive member ADM where the adhesive member ADM the rear surface of the repetitive recessed portion VL′ may be reduced or increased to correspond to the change in the thickness T21.

In an embodiment, a support plates MPL may be arranged below the display module. In an embodiment, slit holes SH for forming the folding pattern (e.g., FP of FIG. 4) may be formed in the support plate MPL. In an embodiment, the slit holes SH may be formed over the second region FP2 and the third region VP. In an embodiment, the slit holes SH may be additionally formed over at least a portion of the first region FP1 adjacent to the third region VP.

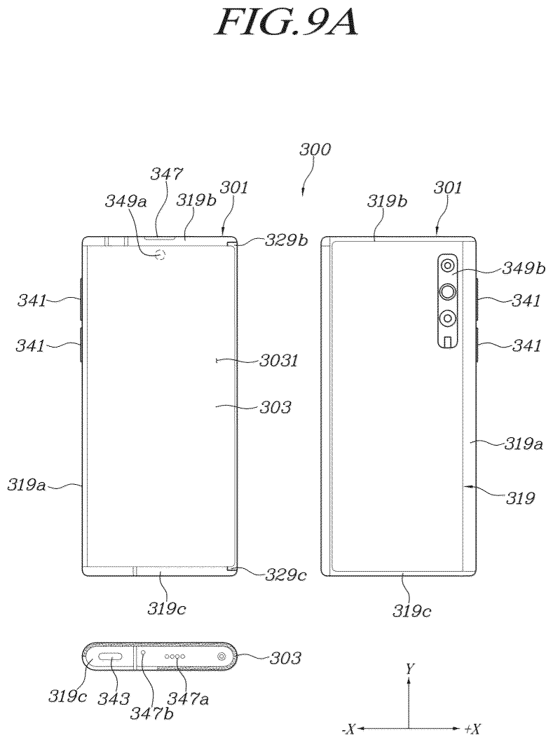

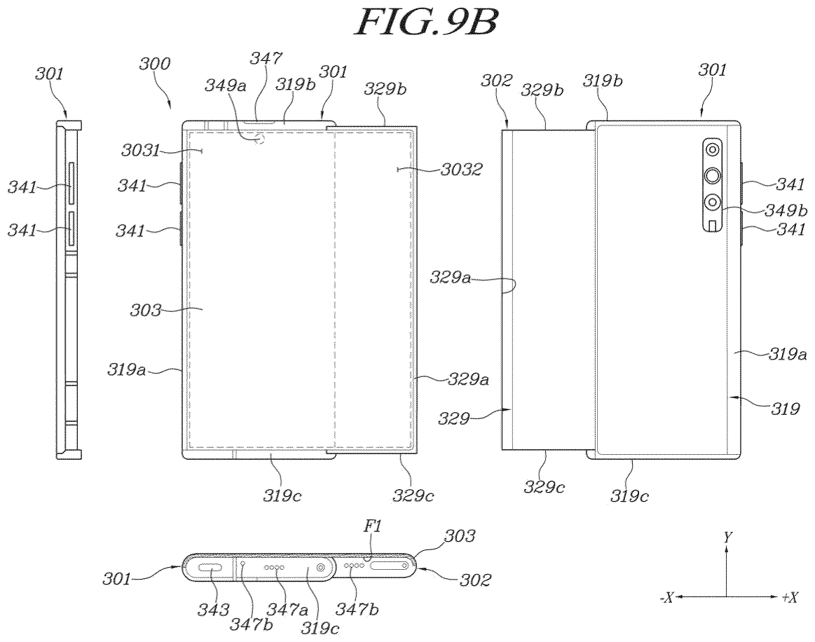

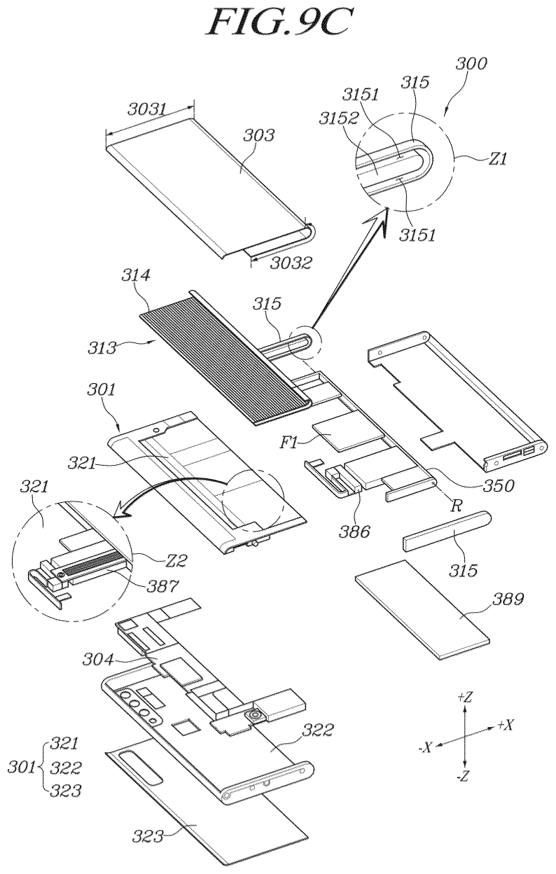

FIG. 9A is a diagram illustrating a first state (e.g., a closed state or a slide-in state) of an electronic device according to an embodiment of the disclosure.

FIG. 9B is a diagram illustrating a second state (e.g., an open state or a slide-out state) of an electronic device according to an embodiment of the disclosure.

The state illustrated in FIG. 9A may be referred to as a state in which an electronic device 300 and/or housings 301 and 302 are closed, and the state illustrated in FIG. 9B may be referred to as a state in which the electronic device 300 and/or the housings 301 and 302 are open. The electronic device 300 may include, for example, a portable device (e.g., a smartphone, a tablet, a portable multimedia device, a portable medical device, a camera, a wearable device), a computing device, or a home appliance. The electronic device 300 according to an embodiment of the disclosure is not limited to the above-described devices.

Referring to FIGS. 9A and 9B, the electronic device 300 may include the housings 301 and 302 and a display 303. The housings 301 and 302 may include a first housing 301 and a second housing 302 disposed to be relatively movable with respect to the first housing 301. According to an embodiment, the first housing 301 may be disposed to reciprocate with respect to the second housing 302 by a predetermined distance.

According to an embodiment, the first housing 301 may be referred to as a first structure, a main part, or a main housing. The second housing 302 may be referred to as a second structure, a slide part, or a slide housing.

According to an embodiment, the first housing 301 may include a first sidewall member 319 surrounding at least a portion of the second housing 302. The first sidewall member 319 may include a first sidewall 319a, a second sidewall 319b, and a third sidewall 319c. According to an embodiment, the second housing 302 may include a second sidewall member 329 surrounding at least a portion of the display 303. The second sidewall member 329 may include a fourth sidewall 329a, a fifth sidewall 329b, and a sixth sidewall 329c. According to an embodiment, one side of the first sidewall member 319 of the first housing 301 may be formed in an open shape to accommodate at least a portion of the second housing 302.

According to an embodiment, the display 303 may include a first display area 3031 and a second display area 3032. According to an embodiment, the first display area 3031 may be disposed to correspond to the first housing 301. The second display area 3032 may extend from the first display area 3031, and may be inserted or slid into the inside of the first housing 301 so as not to be visible from the outside of the first housing 301, or may be visually exposed to the outside of the first housing 301, as the second housing 302 slidably moves.

According to an embodiment, the electronic device 300 may include a key input device 341, a connector hole 343, an audio module 347, and/or camera modules 349a and 349b. According to an embodiment, the connector hole 343 may accommodate a connector (e.g., a USB connector) for transmitting and receiving power and/or data to and from an external electronic device. According to an embodiment, the connector hole 343 may be omitted. According to an embodiment, the audio module 347 may include a first audio module (e.g., a speaker) for providing sound through at least one speaker hole 347a or a second audio module (e.g., a microphone) for receiving sound through at least one microphone hole 347b. According to an embodiment, the camera modules 349a and 349b may include a first camera module 349a (e.g., a front camera) and a second camera module 349b (e.g., a rear camera). According to an embodiment, the first camera module 349a may not be visually exposed to a screen display area (e.g., the first display area 3031) and may include a hidden under display camera (UDC). The second camera module 349b may photograph a subject in a direction opposite to the first display area 3031 of the display 303.

FIG. 9C is an exploded perspective view of a rollable electronic device according to an embodiment.

Referring to FIG. 9C, the electronic device 300 may include a first housing 301, a second housing 302, a display 303 (e.g., a flexible display, a foldable display, or a rollable display), and a support structure 313 (e.g., an articulated hinge structure or a display support member). A portion (e.g., the second display area 3032) of the display 303 may be received into the electronic device 300 (e.g., an inner space of the first housing 301) along a curved surface 350 of the second housing 302. The configuration of the first housing 301, the second housing 302, and the display 303 of FIG. 9C may be entirely or partially the same as that of the first housing 301, the second housing 302, and the display 303 of FIGS. 9A and 9B.

According to an embodiment, the first housing 301 may include a second plate 321 (e.g., a first bracket), a second plate cover 322 (e.g., a book cover or a second bracket), and a third plate 323 (e.g., a rear cover). The second plate 321 may support at least a portion (e.g., the first display area 3031) of the display 303. The PCB 304 may be coupled to the second plate 321. According to an embodiment, the second plate 321 may accommodate components of the electronic device 300. The second plate cover 322 may protect components located on the second plate 321.

According to an embodiment, the first housing 301 may include a PCB 304 on which a processor, a memory, an interface, and/or a radio frequency cable are mounted. According to an embodiment, a battery 389 may supply power to at least one component (e.g., the processor) of the electronic device 300.

According to an embodiment, the third plate 323 may substantially form at least a portion of the exterior of the electronic device 300. According to an embodiment, the second plate 321, the second plate cover 322, and/or the third plate 323 may be made of a material that at least partially transmits light. For example, in a state in which a portion (e.g., the second display area 3032) of the display 303 is received inside the electronic device 300, the electronic device 300 may cause at least a portion of light output from the second display area 3032 to be provided to the outside of the electronic device 300 via second plate cover 322 and/or the third plate 323.

According to an embodiment, the second housing 302 may include a first plate 311 (e.g., a slide plate) and a slide cover 312. The first plate 311 and the slide cover 312 may linearly reciprocate in the width direction (e.g., X-axis direction) of the electronic device 300 with respect to the second housing 302. According to an embodiment, the first plate 311 may support the display 303. For example, the first plate 311 may include a first surface F1 that supports at least a portion of the first display area 3031 in the first state and supports at least a portion of the first display area 3031 and at least a portion of the second display area 3032 in the second state. The slide cover 312 may protect the display 303 located on the first plate 311. For example, the slide cover 312 may surround at least a portion of the display 303, and the at least a portion of the display 303 may be positioned between the first plate 311 and the slide cover 312.

According to an embodiment, the support structure 313 (e.g., the multi-bar assembly) may support at least a portion (e.g., the second display area 3032) of the display 303. The support structure 313 may be connected to the display 303. For example, the support structure 313 may be attached to the display 303. The support structure 313 may be connected to the second housing 302 and may move with respect to the first housing 301 together with the second housing 302. For example, the support structure 313 may be positioned between the first plate 311 and the slide cover 312. According to an embodiment, at least a portion of the support structure 313 may move according to a curved surface 350 located at an edge of the second housing 302. According to an embodiment, the support structure 313 may include a plurality of bars 314 (or a plurality of rods) and a guide rail 315 (e.g., a guide structure). The plurality of bars 314 may extend in a straight line and may be arranged parallel to a rotation axis R formed by the curved surface 350.

According to an embodiment, the guide rail 315 may guide a movement of the plurality of bars 314. The guide rail 315 may include an upper guide rail connected to an upper end of the first plate 311 and upper end portions of the plurality of bars 314, and a lower guide rail connected to a lower end of the first plate 311 and lower end portions of the plurality of bars 314. Referring to a first enlarged area Z1, when a portion of the support structure 313 is bent or slid, the upper end portion and/or the lower end portion of the plurality of bars 314 may move while maintaining a fitting state with the guide rail 315. For example, the plurality of bars 314 may slide along a rail 3151 in a state in which guide protrusions formed at both ends thereof are inserted into the grooved rail 3151 formed inside the guide rail 315. According to an embodiment, by driving of a motor 386, the first plate 311 on which the motor 386 is disposed may slide out, and a protruding portion 3152 inside the guide rail 315 may provide pressure to a plurality of bent bars 314. Accordingly, the display 303 may be expanded. According to an embodiment, by driving of the motor 386, the first plate 311 may slide in, and an outer portion (e.g., a portion other than the protruding portion 3152) of the guide rail 315 may push the plurality of bent bars 314 out. Accordingly, the display 303 may be received between the first plate 311 and the slide cover 312. According to an embodiment, a rack 387 may be disposed in a structure (e.g., the second housing 302) different from the structure in which the motor 386 is disposed. The second enlarged area Z2 represents a rear surface (e.g., a surface facing-Z-axis) of the second plate 321. Referring to the second enlarged area Z2, the rack 387 may be connected to one surface of the second plate 321 of the second housing 302 and may be engaged with a gear (e.g., a pinion gear) connected to the motor 386.

FIGS. 9A and 9B illustrate a structure in which the display 303 (e.g., flexible display) is expanded in the right direction (e.g., +X-axis direction) when viewed from the front surface of the electronic device 300.

Unlike those illustrated in FIGS. 9A to 9C, in an embodiment, the display 303 may be designed to be expandable in the left direction (e.g., −X-axis direction) and/or both directions (e.g., +X-axis direction and −X-axis direction), or may be designed to be expandable in the length direction (e.g., Y-axis direction) of the electronic device 300.

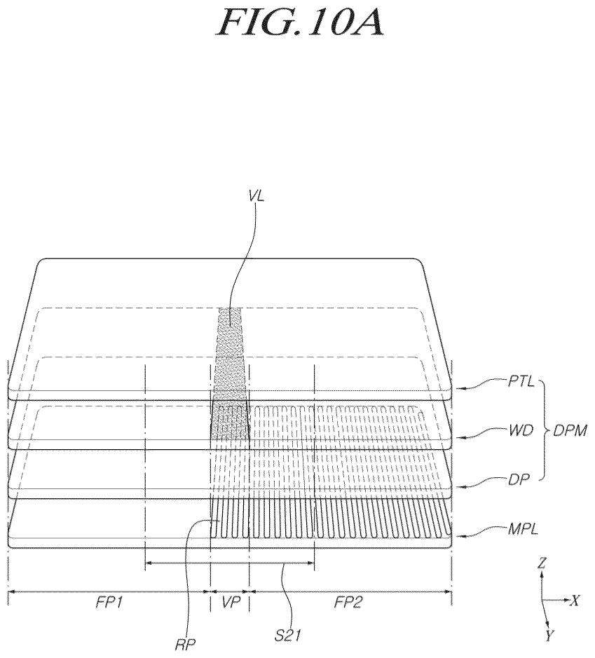

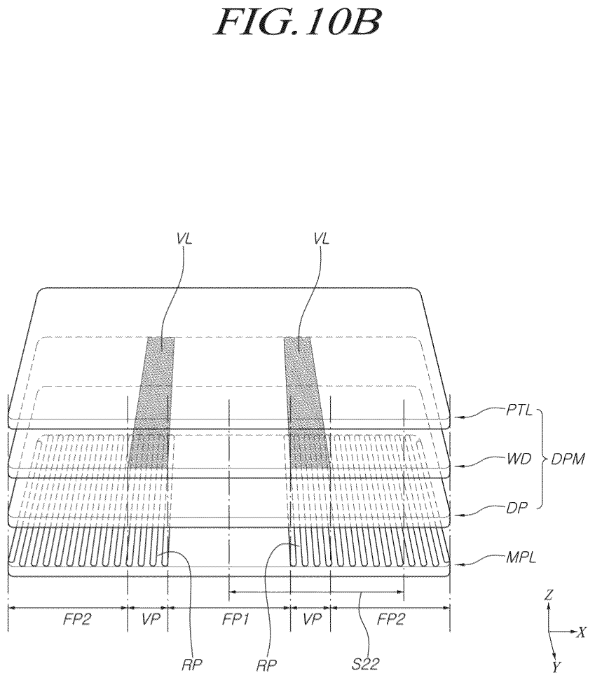

FIGS. 10A and 10B are diagrams respectively illustrating an example of a partial stacking relationship of a rollable electronic device according to an embodiment.

FIG. 10A illustrates an example of a stacking relationship of a rollable electronic device designed to be expandable in one direction.

According to an embodiment, the electronic device may include a display module DPM and a support plate MPL. A protective portion PTL may be provided on a front surface of the display module DPM, and a display panel DP may be provided on a rear surface of the display module DPM, but the disclosure is not limited thereto. Various components may be arranged between the protective portion PTL and the display panel DP. For example, a window WD may be arranged between the protective layer PTL and the display panel DP. At least some of the respective layer components constituting the display module DPM may be bonded by an adhesive member.

In an embodiment, the window WD may have a different thickness for each region. In an embodiment, the window WD may be divided into a thick portion region FP1, a thin portion region FP2, and a recessed portion region VP, and may have a different thickness in each region. The window WD having a thick portion, a thin portion, and a recessed portion VL may be positioned in the thick portion region FP1, the thin portion region FP2, and the recessed portion region VP, respectively.

In an embodiment, the window WD may include a thick portion having a first thickness and a thin portion having a second thickness. In an embodiment, the thick portion may be formed to be thicker than the thin portion (first thickness>second thickness). Accordingly, the thin portion region FP2 of the display module DPM may have rolling characteristics. The display module DPM may be bent using the thin portion region FP2, thereby implementing a rollable electronic device.

In an embodiment, a recessed portion VL may be formed between the thick portion and the thin portion. The recessed portion VL may be connected between the thick portion and the thin portion, forming a variable thickness. In an embodiment, one end of the recessed portion VL may have the same thickness as the thick portion and may be seamlessly connected to the thick portion. In an embodiment, the other end of the recessed portion VL may have the same thickness as the thin portion and may be seamlessly connected to the thin portion. Accordingly, the recessed portion VL may be connected to the thick portion without forming a step. Further, the recessed portion VL may be connected to the thin portion without forming a step.

In an embodiment, the thick portion may extend to one side (e.g., −X-axis direction) of the display module, and the thin portion may extend to the other side (e.g., +X-axis direction) of the display module. In other words, the thick portion and the thin portion may extend in opposite directions to each other.

In an embodiment, the support plate MPL may be coupled to a rear surface of the display panel DP. In an embodiment, the support plate MPL may include a plurality of rolling patterns RP, and the support plate MPL may be bent in an area in which the rolling patterns RP are provided. In an embodiment, the rolling patterns RP of the support plate MPL may be formed in an area corresponding to the thin portion region FP2 and the recessed portion region VP. For example, the rolling patterns RP may be formed over the entire thin portion region FP2. For example, the rolling patterns RP may be formed over the entire or partial region of the recessed portion region VP.

In an embodiment, the thick portion region FP1 of the display module DPM may be kept flat, and the thin portion region FP2 may be bent in a rollable manner. In an embodiment, the display module DPM corresponding to the thin portion region FP2 may be pulled-in into or pulled-out from the housing of the electronic device described above with reference to FIGS. 9A to 9C. The display module DPM in the pulled-in state may be maintained in a state in which the thin portion region FP2 is rolled up, and the display module DPM in the pulled-out state may be maintained in a state in which at least a portion of the thin portion region FP2 is unfolded to be flat.

FIG. 10B illustrates an example of a stacking relationship of a rollable electronic device designed to be expandable in both directions. Specifically, FIG. 10B illustrates an example of a display module DPM having a plurality of thin portion regions FP2, and the description will be made focusing on the difference from the stacking relationship illustrated in FIG. 10A.

In an embodiment, the window may be divided into a thick portion region FP1, two or more thin portion regions FP2, and two or more recessed portion regions VP. This arrangement may be distinguished from that of the display module shown in FIG. 10A divided into one thin portion region and one recessed portion region.

In an embodiment, the thick portion may be located in the middle portion of the window. In an embodiment, the thick portion may be formed perpendicular to the direction in which the display module is rolled.

In an embodiment, the recessed portions VL may be respectively formed between the thick portion and each of the thin portions. In an embodiment, the recessed portions may be formed immediately adjacent to both sides of the thick portion. For example, the left recessed portion may be formed on one side (e.g., −X-axis direction) of the thick portion, and the right recessed portion may be formed on the other side (e.g., +X-axis direction) of the thick portion.

In an embodiment, the thin portions may be located in an outward direction of the recessed portion. For example, the left thin portion may be formed on one side (e.g., −X-axis direction) of the left recessed portion, and the right thin portion may be formed on the other side (e.g., +X-axis direction) of the right recessed portion.

In an embodiment, the recessed portion VL may be connected between the thick portion and the thin portion, forming a variable thickness. In an embodiment, one end of the recessed portion VL may have substantially the same thickness as the thick portion and may be continuously connected to the thick portion. In an embodiment, the other end of the recessed portion VL may have substantially the same thickness as the thin portion and may be continuously connected to the thin portion. Accordingly, the recessed portion VL may be connected to the thick portion without forming a step. Further, the recessed portion VL may be connected to the thin portion without forming a step.

In an embodiment, a support plate MPL may be coupled to a rear surface of the display panel DP. In an embodiment, the support plate MPL may include a plurality of rolling patterns RP, and the support plate MPL may be bent in an area in which the rolling patterns RP are provided. In an embodiment, the rolling patterns RP of the support plate MPL may be formed in an area corresponding to the thin portion region FP2 and the recessed portion region VP. For example, the rolling patterns RP may be formed over the entire thin portion region FP2. For example, the rolling patterns RP may be formed over the entire or partial region of the recessed portion region VP.

Referring to FIGS. 10A and 10B, the back side of the display module DPM and support plate MPL may be provided with additional components for a rollable operation, more specifically, a sliding movement.

The electronic device according to an embodiment may include one or more driving assemblies for a sliding movement in a back side direction of the support plate MPL. The driving assembly may include, for example, a motor, one or more pinions operatively connected to the motor, and one or more racks. Here, the one or more racks may be positioned over at least a portion of the thick portion region FP1. The one or more pinions may be positioned to operatively couple with the one or more racks.

The electronic device according to an embodiment may include a bar for sliding in or sliding out the display module DPM along a guide rail. Here, the bar may be provided in the back side direction of the support plate MPL. The description of the bar is substantially the same as that described above with reference to FIG. 9C. In an embodiment, at least some of the plurality of bars may be arranged over the thin portion region FP2. In an embodiment, at least some of the plurality of bars may be arranged over the recessed portion region VP. Further, in an embodiment, at least some of the plurality of bars may be additionally arranged over a partial area of the thick portion region FP1, but the disclosure is not limited thereto.

Hereinafter, cross-sections of the display module DPM and the support plate MPL corresponding to S21 of FIG. 10A and S22 of FIG. 10B are illustrated.

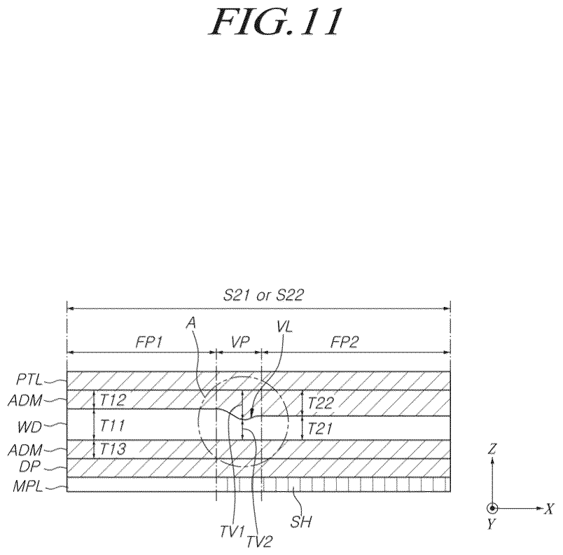

FIGS. 11 to 14 are cross-sectional views respectively illustrating examples of a rollable electronic device according to embodiments.

FIG. 11 is a cross-sectional view of a rollable display module having a window having a recessed portion formed on one surface thereof.

Referring to FIG. 11, the display module may include or be divided into a first region FP1 formed to have a first thickness T11, a second region FP2 formed to have a second thickness T21 less than the first thickness T11, and a third region VP formed between the first region FP1 and the second region FP2.

In an embodiment, the window WD may have substantially the same thickness over the first region FP1. In an embodiment, the window WD may have substantially the same thickness over the second region FP2. In an embodiment, in the third region VP, a recessed portion VL may be formed on one surface of the window WD. The recessed portion VL may be concave downwardly (e.g., in −Z-axis direction) along the vertical direction of the display module. In an embodiment, the window WD may have a first thickness T11 in the first region FP1 and a second thickness T21 in the second region FP2. In an embodiment, the window WD may have a third thickness TV2 in the third region VP.

In an embodiment, the first thickness T11 may be greater than or equal to the second thickness T21. In an embodiment, as the first thickness T11 is formed to be greater than the second thickness T21, the window WD may remain flat in the first region FP1, and may be bent by an external force in the second region FP2. As such, when the second region FP2 is formed to be thin, the display module may have a rollable property in the second region FP2.

In an embodiment, the thickness (the third thickness, TV2) of the recessed portion VL formed in the third region VP may be formed to vary as it moves in the longitudinal direction (e.g., X-axis direction). In an embodiment, the third thickness TV2 may have a maximum thickness at a point contacting the first region FP1. In an embodiment, the third thickness TV2 may have a minimum thickness at one point of the central portion of the third region VP. In an embodiment, the third thickness TV2 may become thicker as it goes from the central portion of the third region VP toward a point abutting the first region FP1 and the second region FP2.

In an embodiment, the third thickness TV2 may be substantially the same as the first thickness T11 at a point where the third region VP contacts the first region FP1. In an embodiment, the third thickness TV2 may be substantially the same as the second thickness T21 at a point where the third region VP contacts the second region FP2.

In an embodiment, the first thickness T11, that is, the thickness of the thick portion may have a length of 40 μm to 500 μm. In an embodiment, the second thickness T21, that is, the thickness of the thin portion may have a length of 10 μm to 80 μm.

As illustrated in FIG. 11, a recessed portion VL may be formed on one surface of the window WD, and a recessed portion VL may not be formed on the other surface facing the one surface of the window WD. In other words, the surface facing the surface on which the recessed portion VL is formed may be formed to be flat.

In an embodiment, the rollable display module may be rollable using the second region FP2 and the third region VP, and the first region FP1 may be maintained in a flat state while it is rolled or unfolded by the second region FP2 and the third region VP.

In an embodiment, the display module may further include an adhesive member (ADM) bonding other layer components as described above with reference to FIG. 2. The layer components may include, for example, a protective layer PTL, a display panel DP, or another functional layer. In an embodiment, the layer components may be classified based on positional relationship with the window WD. For example, the components arranged above the window WD may be referred to as a first layer component (e.g., the protective layer PTL), and the components arranged underneath the window WD may be referred to as a second layer component (e.g., the display panel DP).

In an embodiment, the adhesive member ADM may bond the first layer component and the window WD, and the second layer component and the window WD.

In an embodiment, the adhesive member ADM bonding the window WD and the first layer component may have the same thickness or different thicknesses for each of the first to third regions FP1, FP2, and VP.

In an embodiment, the adhesive member ADM may be positioned on both sides of the window WD or either side thereof. For example, the adhesive member ADM may be formed on the front surface of the window WD. For example, the adhesive member ADM may be formed on the front surface and the rear surface of the window WD.

In an embodiment, the adhesive members ADM may be arranged such that the upper side of the window WD is flattened. For example, the adhesive member ADM may be formed to have different thicknesses in the first region FP1, the second region FP2, and the third region VP. In an embodiment, a sum of the thickness of the adhesive member ADM and the thickness of the window WD may be uniformly formed over the entire area. For example, the sum of the thickness T12 and the thickness T11 in the first region FP1, the sum of the thickness T22 and the thickness T21 in the second region FP2, and the sum of the thickness TV1 and the thickness TV2 in the third region VP may be formed to be the same altogether.

Specifically, the adhesive member ADM may have a thickness T12 from the front surface of the window WD to the rear surface of the first layer component in the first region FP1, a thickness T22 in the second region FP2, and a thickness TV1 in the third region VP. The thickness T22 may be greater than or equal to the thickness T12. The maximum value of the thickness TV1 may be greater than the thickness T22, and the minimum value thereof may be equal to the thickness T12.

In an embodiment, the adhesive members ADM arranged on the rear surface of the window WD may be formed to have the same thickness T13 over the first to third areas FP1, FP2, and VP. As the rear surface of the window WD and the front surface of the second layer component (e.g., the display panel DP) bonded to the window WD are formed parallel to each other, the adhesive member ADM may be maintained to have substantially the same thickness between the window WD and the second layer component. In an embodiment, the adhesive member ADM bonding the window WD and the second layer component may be formed to have a thickness T13 from the rear surface of the window WD to the front surface of the second layer component in the first to third regions FP1, FP2, and VP. The thickness T13 may be equal to or different from any one of the first length T12 or the second length T22.

As described above, the window WD applied to an embodiment of the disclosure has the recessed portion VL formed in the third region VP, so that the force applied by the window WD to the adhesive member ADM during its repeated rolling operation may be transmitted in a vertical direction rather than a horizontal direction. When the window WD is repeatedly rolled, the force may generally be transferred from the window WD to the adhesive member ADM. When this force is repeatedly transmitted in the horizontal direction, the adhesive member ADM may be delaminated from the window WD. According to an embodiment, due to the recessed portion VL formed in the window WD, the force resulting from the rolling operation may be transmitted in the vertical direction rather than the horizontal direction, and delamination between the adhesive member ADM and the window WD may be minimized.

Further, the window WD according to an embodiment adopts a structure in which the first and second regions FP1 and FP2 and the third region VP in which the recessed portion VL is formed are connected to each other in a gentle curved surface, and thus the boundary between the first region FP1 and the third region VP and the boundary between the second region FP2 and the third region VP may not be visible to the naked eyes. For example, two kinds of thicknesses may be realized by performing a masking process and an etching process on one area of the window substrate to form a thin portion, but a step difference between the thin portion and the thick portion may be easily visible even if it is polished. A manufacturing method according to an embodiment of the disclosure makes it possible to form a recessed portion having various radius of curvature through a spray etching and further, manufacture a window with the structure in which a boundary between the thin portion and the thick portion is not visually recognized.

In an embodiment, the adhesive member ADM may be made of a material having the same optical properties as that of the window WD. The adhesive member ADM may be made of, for example, a polymer material having a light refractive index substantially equal to or corresponding to that of the window WD. As the window WD and the adhesive member ADM have substantially the same or corresponding light refractive index, the light refractive characteristics may not deteriorate even if the boundary between the window WD and the adhesive member ADM is complicatedly formed.

In an embodiment, the support plate MPL may be arranged underneath the display module. In an embodiment, slit holes SH for forming rolling patterns (e.g., RP of FIGS. 10A and 10B) may be formed in the support plate MPL. In an embodiment, the slit holes SH may be formed over the second region FP2 and the third region VP. In an embodiment, the slit holes SH may be also formed additionally over at least a portion of the first region FP1 adjacent to the third region VP.

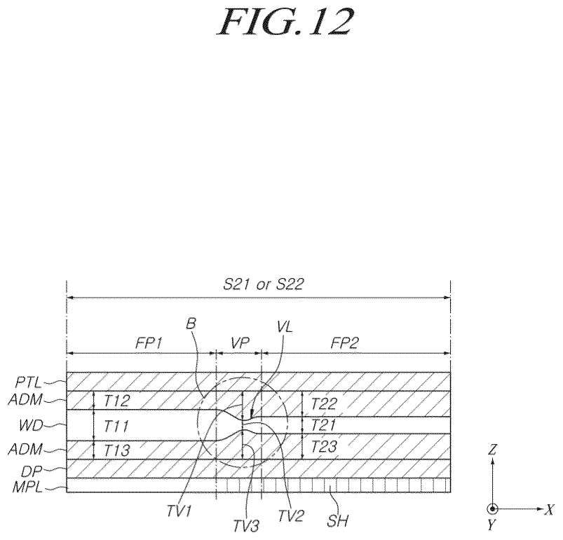

FIG. 12 is a cross-sectional view of a rollable display module having a window with a recessed portion formed on both surfaces.

Referring to FIG. 12, in an embodiment, the display module may include or be divided into a first region FP1 having a first thickness T11, a second region FP2 having a second thickness T21 less than the first thickness T11, and a third region VP formed between the first region FP1 and the second region FP2.

In an embodiment, the thick portion may have a thickness of 40 μm to 500 μm as the first thickness T11, and the thin portion may have a thickness of 10 μm to 80 μm as the second thickness T21. As the window WD illustrated in FIG. 12 has different shapes of the window WD and the adhesive member ADM in the third region VP compared to the window WD illustrated in FIG. 11, the description will be mainly made of such a difference.

Referring to FIG. 12, in an embodiment, recessed portions VL may be formed on both surfaces of the window WD. The recessed portions VL formed on both surfaces may be formed symmetrically with respect to each other, although embodiments are not limited thereto, and the recessed portion formed on the front surface and the recessed portion formed on the rear surface of the window WD may have different shapes.

In an embodiment, the adhesive member ADM may be formed to have thicknesses TV1 and TV3 that vary over the first to third regions FP1, FP2, and VP. The window WD may have different thickness for each region. For example, the first region FP1 may have a first thickness T11. For example, the second region FP2 may have a second thickness T21. For example, the third region VP may have a third thickness TV2. In an embodiment, the first layer component (e.g., PTL) and the second layer component (e.g., DP) bonded by the adhesive member ADM with the window WD may be provided in a flat shape.

In an embodiment, the adhesive member ADM arranged between the front surface of the window WD and the first layer component may be formed with a thickness TV1 that varies corresponding to a change in thickness of the window WD. In an embodiment, the adhesive member ADM bonding the window WD and the first layer component may have a first length T12 from the front surface of the window WD to the rear surface of the first layer component in the first region FP1. In an embodiment, the adhesive member ADM bonding the window WD and the first layer component may be formed to have a second length T22 from the front surface of the window WD to the rear surface of the first layer component in the second region FP2 and to have a third length TV1 from the front surface of the window WD to the rear surface of the first layer component in the third region VP. The second length T22 may be greater than or equal to the first length T12. The maximum value of the third length TV1 may be greater than the second length T22, and the minimum value of the third length TV1 may be equal to the first length T12.

In an embodiment, the adhesive member ADM arranged between the rear surface of the window WD and the second layer component may be formed with a thickness TV3 that varies corresponding to a change in thickness of the window WD. In an embodiment, the adhesive member ADM bonding the window WD and the second layer component may be formed to have a fourth length T13 from the rear surface of the window WD to the front surface of the second layer component in the first region FP1, a fifth length T23 from the rear surface of the window WD to the front surface of the second layer component in the second region FP2, and a sixth length TV3 from the rear surface of the window WD to the front surface of the second layer component in the third region VP. The fifth length T23 may be greater than or equal to the fourth length T13. The maximum value of the sixth length TV3 may be greater than the fifth length T23, and the minimum value thereof may be equal to the fourth length T13.

As such, the window WD illustrated in FIG. 12 may minimize distortion in its shape by a compressive stress or an expansion stress during a chemical reinforcement, by using such a structure. In the window illustrated in FIGS. 11 and 12, respectively, the aforementioned recessed portion may be made by processes such as CNC, polishing or the like. In an embodiment, the recessed portion may be made, for example, using a chemical etching process or a spray etching process. The recessed portion according to an embodiment of the disclosure is not limited to those made by the above-described process, and may be made by various other physical and/or chemical processes as required.

Further, in an embodiment, the support plates MPL may be arranged underneath the display module. In an embodiment, slit holes SH for forming the rolling patterns (e.g., RP of FIGS. 10A and 10B) may be formed in the support plate MPL. In an embodiment, the slit holes SH may be formed over the second region FP2 and the third region VP. In an embodiment, the slit holes SH may be formed additionally over at least a portion of the first region FP1 adjacent to the third region VP.

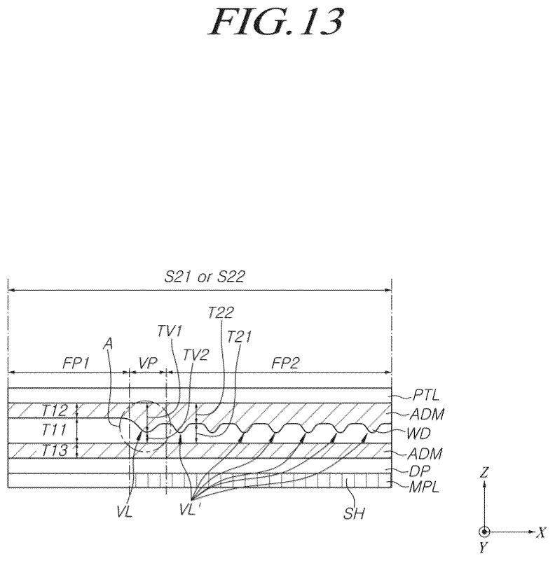

FIG. 13 is a cross-sectional view of a rollable display module having a window with a plurality of recessed portions formed therein.

Referring to FIG. 13, in an embodiment, an edge recessed portion VL adjacent to the first region FP1 and a plurality of repetitive recessed portions VL′ continuously formed in a direction away from the first region FP1 may be formed on the front surface of the window WD.

In an embodiment, the edge recessed portion VL may be formed in the third region VP. The third region VP may be positioned adjacent to the first region FP1.

In an embodiment, the repetitive recessed portion VL′ may be formed in the second region FP2. Although embodiments are not limited thereto, the repetitive recessed portions VL′ formed in the second region FP2 may be formed to have the same shape (e.g., height and width).

In an embodiment, the edge recessed portion VL may have the shape that is the same as or different from that of the repetitive recessed portion VL′. In an embodiment, the edge recessed portion VL may have a maximum thickness greater than that of the repetitive recessed portion VL′. In an embodiment, the edge recessed portion VL may have the same minimum thickness as that of the repetitive recessed portion VL′.

In an embodiment, the edge recessed portion VL may be formed such that the thickness TV2 decreases and then increases again as it moves away from the first region FP1. Correspondingly, the adhesive member ADM contacting the front surface of the edge recessed portion VL may be formed such that the thickness TV2 increases and then decreases again as it moves away from the first region FP1.

In an embodiment, the repetitive recessed portion VL′ may be formed such that the thickness T21 decreases and then increases again as it moves away from the first region FP1. Correspondingly, the adhesive member ADM contacting the front surface of the repetitive recessed portion VL′ may be formed such that the thickness T22 increases and then decreases again as it moves away from the first region FP1.

In an embodiment, the adhesive member ADM contacting the rear surface of the window WD may have substantially the same thickness T13 over the entire area.

In an embodiment, the support plates MPL may be arranged underneath the display module. In an embodiment, slit holes SH for forming the rolling pattern (e.g., RP of FIGS. 10A and 10B) may be formed in the support plate MPL. In an embodiment, the slit holes SH may be formed over the second region FP2 and the third region VP. In an embodiment, the slit holes SH may be additionally formed over at least a portion of the first region FP1 adjacent to the third region VP.

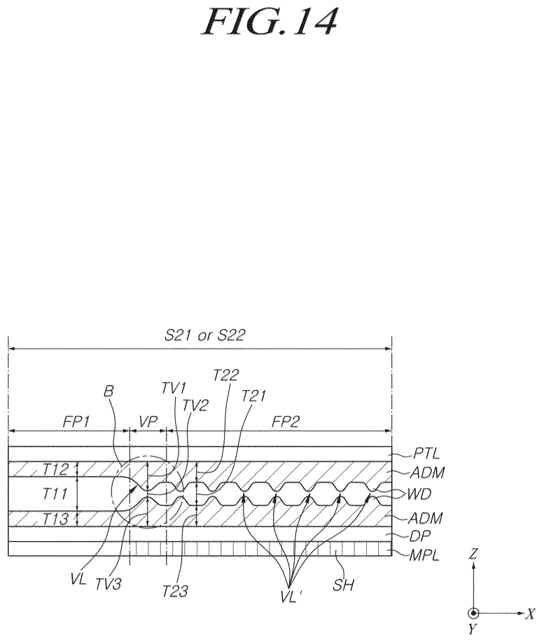

FIG. 14 is a cross-sectional view of a rollable display module having a window with a plurality of recessed portions formed on both sides.

Referring to FIG. 14, in an embodiment, an edge recessed portion VL adjacent to the first region FP1 and a plurality of repetitive recessed portions VL′ continuously formed in a direction away from the first region FP1 may be formed on both surfaces of the window WD. In an embodiment, the edge recessed portions VL formed on both surfaces may be symmetrically formed, although embodiments are not limited thereto, and the recessed portion formed on the front surface and the recessed portion formed on the rear surface may be formed to have different depths. In an embodiment, the repetitive recessed portion VL′ formed on both surfaces may be symmetrically formed, although embodiments are not limited thereto, and the recessed portion formed on the front surface and the recessed portion formed on the rear surface may be formed to have different depths.

In an embodiment, the edge recessed portion VL may be formed in the third region VP. The third region VP may be positioned adjacent to the first region FP1.

In an embodiment, the repetitive recessed portions VL′ may be formed in the second region FP2. The repetitive recessed portions VL′ formed in the second region FP2 may be formed to have the same shape (e.g., height and width), although embodiments are not limited thereto.

In an embodiment, the edge recessed portion VL may have the shape that is the same as or different from that of the repetitive recessed portion VL′. In an embodiment, the edge recessed portion VL may have a maximum thickness greater than that of the repetitive recessed portion VL′. In an embodiment, the edge recessed portion VL may have the same minimum thickness as the repetitive recessed portion VL′.

In an embodiment, the edge recessed portion VL may be formed such that the thickness TV2 decreases and then increases again as it moves away from the first region FP1. Correspondingly, the adhesive member ADM contacting the front surface of the edge recessed portion VL may be formed such that the thickness TV2 increases and then decreases again as it moves away from the first region FP1. Further, likewise, the adhesive member ADM contacting the rear surface of the edge recessed portion VL may be formed such that the thickness TV3 increases and then decreases again as it moves away from the first region FP1.

In an embodiment, the repetitive recessed portion VL′ may be formed such that the thickness T21 decreases and then increases again as it moves away from the first region FP1. Correspondingly, the adhesive member ADM contacting the front surface of the repetitive recessed portion VL′ may be formed such that the thickness T22 increases and then decreases again as it moves away from the first region FP1. Further, likewise, the adhesive member ADM contacting the rear surface of the repetitive recessed portion VL′ may be formed such that the thickness TV3 increases and then decreases again as it moves away from the first region FP1.

Further, in an embodiment, the support plates MPL may be arranged underneath the display module. In an embodiment, slit holes SH for forming the rolling pattern (e.g., RP of FIGS. 10A and 10B) may be formed in the support plate MPL. In an embodiment, the slit holes SH may be formed over the second region FP2 and the third region VP. In an embodiment, the slit holes SH may be additionally formed over at least a portion of the first region FP1 adjacent to the third region VP.

FIG. 15 is an enlarged view of a recessed portion formed on one surface of a window according to an embodiment.

In an embodiment, the recessed portion VL formed on one surface of the window WD may be formed over the third region VP. In an embodiment, a first outer edge VE1 of the recessed portion VL may be connected to the first region FP1 of the window WD, and a second outer edge VE2 may be connected to the second region FP2 of the window WD.

According to an embodiment, the recessed portion VL may include a first curved portion having a first radius of curvature VR1, a second curved portion having a second radius of curvature VR2, and a third curved portion having a third radius of curvature VR3. The first curved portion and the third curved portion may be connected by an inclined portion (e.g., an inclined surface). The second curved portion and the third curved portion may be connected by another inclined portion (e.g., an inclined surface).

According to an embodiment, at the boundary between the third region VP and the first region FP1, the recessed portion VL may form the first radius of curvature VR1 and may extend toward the first region FP1. At the boundary between the third region VP and the second region FP2, the recessed portion VL may form the second radius of curvature VR2 and may extend toward the second region FP2.

Further, the recessed portion VL may be formed to be concave downwardly from at least a portion between the first outer edge VE1 and the second outer edge VE2. Here, the shape concave downwards may have the third radius of curvature VR3.

In an embodiment, the first radius of curvature VR1 may be formed to be greater than or equal to the second radius of curvature VR2 and/or the third radius of curvature VR3. The second radius of curvature VR2 may be formed to be greater than or equal to the third radius of curvature VR3. In an embodiment, the first radius of curvature VR1 may be the largest among the first, second, and third radius of curvature VR1, VR2, and VR3.

In an embodiment, a vertical distance (e.g., upper depth VD) from the front surface of the recessed portion VL to the front surface of the thin portion may have a depth of at least 5 μm with respect to the front surface of the thin portion. In an embodiment, the upper depth VD may be defined as a difference in thickness between a point where the recessed portion VL has a minimum thickness and the thin portion. In an embodiment, the upper depth VD may be formed in a range of 10% to 15%, a range of 10% to 20%, a range of 15% to 20%, or 20% or less of the thickness of the thin portion.

In an embodiment, the recessed portion VL may have an inclined surface adjacent to the thick portion (e.g., a first inclined surface or an inclined surface in the thick portion) and an inclined surface adjacent to the thin portion (e.g., a second inclined surface or an inclined surface in the thin portion). In an example, the first inclined surface may form a first inclination angle AG1 with the front surface of the thick portion, wherein the first inclination angle AG1 may have an inclination of less than 1 degree or preferably less than 0.7 degree. In an example, the second inclined surface may form a second inclination angle AG2 with the front surface of the thin portion. As the step difference VD between the thin portion and the recessed portion is not relatively large, the second inclination angle AG2 may be formed to be greater than or equal to the first inclination angle AG1, although embodiments are not limited thereto.

As such, when the inclination of the inclined surface in the thick portion is formed to be less than 1 degree, the visibility in the boundary between the thick portion and the recessed portion may be improved. More specifically, typically, the first inclination angle AG1 of the inclined surface of the thick portion may be formed in a range of 1 to 50 degrees, preferably 3 to 20 degrees, in which case the boundary between the thick portion and the recessed portion may be easily visible. When the thick portion is formed to be thicker than the thin portion, the difference VD′ between the minimum thickness of the recessed portion VL and the thickness of the thick portion may be greater than the difference VD between the minimum thickness of the recessed portion VL and the thickness of the thin portion. As the thickness difference VD′ between the recessed portion VL and the thick portion increases, the boundary therebetween is more likely to be visually recognized, and thus, the recessed portion VL may form the first radius of curvature VR1 at a point where it comes into contact with the thin portion VL, and at the same time, the inclined surface in the thin portion may have an inclination of less than 1 degree, so that the boundary may not be visually recognized.

FIG. 16 is an enlarged view of recessed portions formed on both surfaces of the window according to an embodiment.

In an embodiment, the recessed portions VL of both surfaces of the window WD may be formed over the third region VP. In an embodiment, a first outer edge VE1 of the recessed portions VL may be connected to the first region FP1 of the window WD, and a second outer edge VE2 may be connected to the second region FP2 of the window WD.

According to an embodiment, an upper recessed portion VL may include a 1-1st curved portion having a 1-1st radius of curvature VR11, a 2-1st curved portion having a 2-1st radius of curvature VR21, and a 3-1st curved portion having a 3-1st radius of curvature VR31. The 1-1st curved portion and the 3-1st curved portion may be connected to each other by an upper inclined portion (i.e., an inclined surface). The 2-1st curved portion and the 3-1st curved portion may be connected to each other by another upper inclined portion (i.e., an inclined surface).

According to an embodiment, a lower recessed portion VL may include a 1-2nd curved portion having a 1-2nd radius of curvature VR12, a 2-2nd curved portion having a 2-2nd radius of curvature VR22, and a 3-2nd curved portion having a 3-2nd radius of curvature VR32. The 1-2nd curved portion and the 3-2nd curved portion may be connected to each other by a lower inclined portion (i.e., an inclined surface). The 2-2nd curved portion and the 3-2nd curved portion may be connected to each other by another lower inclined portion (e.g., an inclined surface).

According to an embodiment, at the boundary between the third region VP and the first region FP1, the recessed portions VL may form a 1-1st radius of curvature VR11 on one surface (e.g., the front surface) and extend toward the first region FP1, and may form a 1-2nd radius of curvature VR12 on the other surface (e.g., the rear surface) and extend toward the first region FP1.

According to an embodiment, at the boundary between the third region VP3 and the second region FP2, the recessed portions VL may form a 2-1st radius of curvature VR21 on one surface and may extend toward the second region FP2, and may form a 2-2nd radius of curvature VR22 on the other surface and may extend toward the second region FP2.

Further, the recessed portions VL may be made to have upwardly and downwardly recessed shapes (e.g., concave shapes) in at least a portion between the first outer edge VE1 and the second outer edge VE2. In an embodiment, the recessed portion formed on the upper side may be referred to as an upper recessed portion and the recessed portion formed on the lower side may be referred to as a lower recessed portion, and then the upper recessed portion may have a 3-1st radius of curvature VR31 and the lower recessed portion may have a 3-2nd radius of curvature VR32.

In an embodiment, the upper recessed portion and the lower recessed portion may be formed over the third region VP, respectively. The upper recessed portion and the lower recessed portion may be formed substantially across the third region VP. A starting point of change in the upper recessed portion and a starting point of change in the lower recessed portion may be substantially the same with respect to a longitudinal direction (e.g., X-axis of FIG. 5). Further, an end point of change in the upper recessed portion and an end point of change in the lower recessed portion may be substantially the same with respect to the longitudinal direction.

In an embodiment, the 1-1st radius of curvature VR11 may be formed to be greater than or equal to the 2-1st radius of curvature VR21 and/or the 3-1st radius of curvature VR31. The 2-1st radius of curvature VR21 may be formed to be greater than or equal to the 3-1st radius of curvature VR31. In an embodiment, the 1-1st radius of curvature VR11 may be the largest among the 1-1st, 2-1st, and 3-1st radiuses of curvature (VR11, VR21, VR31).

In an embodiment, the 1-2nd radius of curvature VR12 may be formed to be greater than or equal to the 2-2nd radius of curvature VR22 and/or the 3-2nd radius of curvature VR32. The 2-2nd radius of curvature VR22 may be formed to be greater than or equal to the 3-2nd radius of curvature VR32. In an embodiment, the 1-2nd radius of curvature VR12 may be the largest among the 1-2nd, 2-2nd, and 3-2nd radiuses of curvature (VR12, VR22, VR32).

In an embodiment, one or more radiuses of curvature on the upper recessed portion may be formed to be the same as or different from one or more radiuses of curvature on the lower recessed portion formed on the other surface facing on the basis of an XY plane. Further, in an embodiment, the inclinations of each inclined surface of the upper recessed portion and the lower recessed portion may be formed to be the same as or different from each other.

In an embodiment, the vertical distance (e.g., the upper distance VD1) from the front surface of the upper recessed portion to the front surface of the thin portion and the vertical distance (e.g., the lower distance VD2) from the rear surface of the lower recessed portion to the rear surface of the thin portion may have a difference of at least 10 μm or 0 to 10 μm from. In addition, in an embodiment, the upper distance VD1 may have a depth of at least 5 μm or more with respect to the front surface of the thin portion. In an embodiment, the lower distance VD2 may have a depth of at least 5 μm or more with respect to the rear surface of the thin portion.

In an embodiment, the recessed portion VL may have an inclined surface adjacent to the thick portion and an inclined surface adjacent to the thin portion. More specifically, the upper recessed portion may have an upper first inclined surface and an upper second inclined surface, and the lower recessed portion may have a lower first inclined surface and a lower second inclined surface. The upper first inclined surface is an inclined surface located adjacent to the thick portion, and the upper second inclined surface is an inclined surface located adjacent to the thin portion. The lower first inclined surface is an inclined surface located adjacent to the thick portion, and the lower second inclined surface is an inclined surface located adjacent to the thin portion. The upper inclined surfaces (e.g., the upper first and second inclined surfaces) and the lower inclined surfaces (e.g., the lower first and second inclined surfaces) may have a shape symmetrical to each other, but are not limited thereto.

In an example, the upper first inclined surface may form a 1-1st inclined angle AG11 with the front surface of the thick portion, and the 1-1st inclined angle AG11 may have an inclination of less than 1 degree, or less than 0.7 degree. In an example, the upper second inclined surface may form a 2-1st inclined angle AG21 with the front surface of the thin portion.

In an example, the lower first inclined surface may form a 1-2nd inclined angle AG12 with the rear surface of the thick portion, and the 1-2nd inclined angle AG12 may have a slope of less than 1 degree or less than 0.7 degree. In an example, the lower second inclined surface may form a 2-2nd inclined angle AG22 with the rear surface of the thin portion.

As such, when the inclination of the upper and/or lower first inclined surfaces is formed to be less than 1 degree, the visibility of the boundary between the thick portion and the recessed portion may be improved. More specifically, when the thick portion is formed to be thicker than the thin portion, the difference (VD1′ and VD2′) between the minimum thickness of the recessed portion VL and the thickness of the thick portion may be greater than the difference (VD1 and VD2) between the minimum thickness of the recessed portion VL and the thickness of the thin portion. As the thickness difference (VD1′ and VD2′) between the recessed portion (VL) and the thick portion increases, their boundary is more likely to be visually recognized, and thus, the recessed portion VL forms the 1-1st radius of curvature VR11 and the 1-2nd radius of curvature VR12 at a point contacting the thin portion, and simultaneously, the inclined surface(s) in the thin portion has an inclination of less than 1 degree, so that the boundary may not be visually recognized.

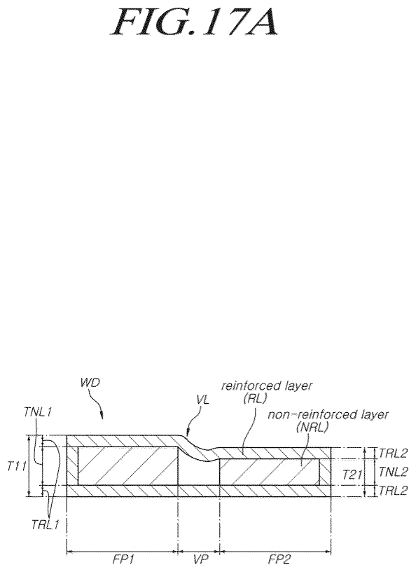

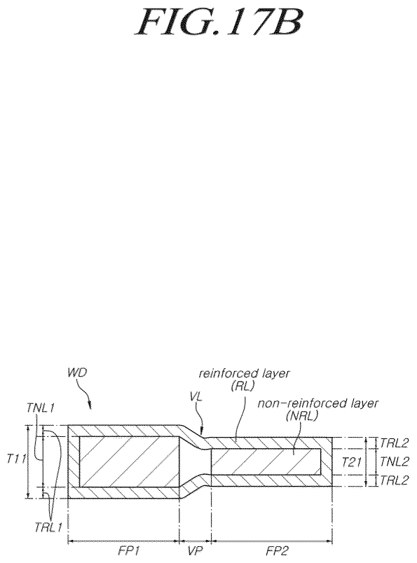

FIGS. 17A and 17B are cross-sectional views illustrating a chemically reinforced window, according to embodiments.

In an embodiment, the window WD may include a reinforced portion RL formed by chemical reinforcement and a non-reinforced portion NRL surrounded by the reinforced portion RL. The reinforced portion RL may be understood as a compression stress layer formed by the chemical reinforcement, and the non-reinforced portion NRL may be understood as the remaining portion except for the compression stress layer.

The chemical reinforcement is, for example, a method of designing a compression stress layer on a surface of glass by converting alkali ions inside a glass material into other alkali ions. In general, a method of exchanging alkali ions in glass for alkali ions in molten salt by depositing a glass material in a molten salt may be used for the chemical reinforcement. The chemical reinforcement may be classified into two types of methods, that is, a low-temperature type and a high-temperature type according to the temperature of the molten salt. The reinforced portion RL according to an embodiment of the disclosure is illustrated to be formed by the chemical reinforcement, but is not limited thereto, and the reinforced portion RL may be formed by a physical reinforcement.

The physical reinforcement is, for example, a method of heating a surface of a glass material near to its softening point and then cooling it with air, so as to form a compression stress layer using a difference in contraction between the surface and the inside.

In the case of chemical reinforcement, surface compression stress (CS) and depth of layer (DOL) of the compression stress layer are important. The CS represents a degree of the compressive stress on the glass surface and is measured in MPa. The DOL represents a depth from the glass surface of a region where the compression stress is formed and is measured in um. The compression stress is generated from volume expansion due to ion substitution, and may also be referred to as “expansion stress”.

Referring to FIG. 17A, in the case of a single-sided etching structure, the thick portion may include a reinforced portion RL and a non-reinforced portion NRL, and based on the height direction (e.g., Z-axis of FIG. 4), the first thickness T11 of the first region FP1 may correspond to a sum of the reinforced portion thickness TRL1 and the non-reinforced portion thickness TNL1. Further, the second thickness T21 of the second region FP2 may correspond to a sum of the reinforced portion thickness TRL2 and the non-reinforced portion thickness TNL2.

Referring to FIG. 17B, in the case of a double-sided etching structure, the first thickness T11 of the first region FP1, based on the height direction, may correspond to a sum of the reinforced portion thickness TRL1 and the non-reinforced portion thickness TNL1. Further, the second thickness T21 of the second region FP2 may correspond to a sum of the reinforced portion thickness TRL2 and the non-reinforced portion thickness TNL2.

Referring to FIGS. 17A and 17B, the thicknesses TRL1 and TRL2 of one reinforced portion RL may be formed to have a DOL in the range of 10% to 20% of the first thickness T11. In an embodiment, the thickness of the reinforced portion RL may be formed to have a DOL in the range of 10% to 20% of the first thickness T11 and/or the second thickness T21, based on at least one of the first thickness T11 and/or the second thickness T21.

In an embodiment, the thickness TRL1 of the reinforced portion RL for the first region FP1 may be formed to have a DOL in the range of 10% to 20% of the first thickness T11, and the thickness TRL2 of the reinforced portion RL for the second region FP2 may be formed to have a DOL in the range of 10% to 20% of the second thickness T21.

In an embodiment, the thickness of the reinforced portion RL corresponding to the third region VP may be formed to have a DOL in the range of 10% to 20% of the first thickness T11 or may be formed to have a DOL in the range of 10% to 20% of the second thickness T21. In an embodiment, the thickness of the reinforced portion RL corresponding to the third region VP may be formed to have a DOL in the range of 10% to 20% of the first thickness T11 at least partially, and may be formed to have a DOL in the range of 10% to 20% of the second thickness T21 in the remaining part.

In an embodiment, the entire process of chemical reinforcement may include a primary chemical reinforcement for the thick portion and the thin portion, and a secondary chemical reinforcement for the thick portion to supplement any chemical reinforcement insufficient for the thick portion following the primary chemical reinforcement. Using the first and second chemical reinforcement processes, a window having different DOLs in the first region and the second region may be manufactured.

Table 1 shows a result of an experiment of the amount of expansion for a window with a width of 150 mm and a length of 150 mm in which DOL is chemically strengthened to a thickness of 6 μm, which is of a 15% level with respect to a thin portion having a thickness of 40 μm. Referring to the experimental result, as the thickness of the thick portion becomes thicker, the ratio of the reinforced layer (i.e., the reinforced portion) and the entire layer (i.e., the chemically reinforced thin portion and thick portion) compared to the thin portion decreases relatively, and therefore, it may be seen that the expansion length decreases. Accordingly, the length difference from the thin portion increases, and appearance distortion and quality deterioration may occur due to the difference in the direction of expansion stress.

TABLE 1

| | | | | | | | Length (mm) | |
|---|---|---|---|---|---|---|---|---|
| | | | Reinforced Layer/ | | Expansion Length | | (Thick | |
| Depth (μm) | | Depth Step | Entire Layer | | (mm) | | Portion − | |
| Thick | Thin | Difference | Thick | Thin | Plane | Rolling | Thin | Bending |
| Portion | Portion | (μm) | Portion | Portion | Portion | Portion | Portion) | (mm) |
| 40 | 40 | 0 | 0.300 | 0.300 | 0.195 | 0.195 | 0.000 | 0 |
| 60 | 40 | 20 | 0.200 | 0.300 | 0.130 | 0.195 | 0.065 | 1.75 |
| 70 | 40 | 30 | 0.200 | 0.300 | 0.111 | 0.195 | 0.084 | 1.79 |
| 80 | 40 | 40 | 0.150 | 0.300 | 0.098 | 0.195 | 0.098 | 2.0 |
| 90 | 40 | 50 | 0.133 | 0.300 | 0.087 | 0.195 | 0.108 | 2.23 |

Table 2 shows an experimental example for explaining the distortion bending phenomenon after chemical reinforcement of the window. The experimental example of Table 2 was carried out for the window having the rear and thin portions of thicknesses of 50 μm and 30 μm, respectively.

TABLE 2

| | | Single-sided | Double-sided | |
|---|---|---|---|---|
| | | Asymmetric | Etching | |
| Classification | | Structure | Structure | Remarks |
| Glass Thickness | | 50 um/30 um | 50 um/30 um | |
| (Thick Portion/Thin | | | | |
| Portion) | | | | |
| Reinforcement Depth | | 6 um/6 um | 6 um/6 um | |
| Characteristics (DOL) | | | | |
| (Thick Portion/Thin | | | | |
| Portion) | | | | |
| Bending | Glass | Average 1.30 | Average 0.61 | Raised Height - |
| | | Maximum 2.46 | Maximum 1.74 | Substrate Thickness |
| | After Glass | 1.1 | 0.58 | The same as |
| | Protective Coating | | | above |

| | | |
|---|---|---|
| Visibility of Boundary Crease | Strong | Weak |
| between Heterogeneous | | |
| Thicknesses | | |

Table 3 shows an experimental example for explaining the distortion bending phenomenon after chemical reinforcement of the window. The experimental example of Table 3 was carried out for the window having the rear and thin portions of thicknesses of 70 μm and 30 μm, respectively.

TABLE 3

| | | Single-sided | Double-sided | |
|---|---|---|---|---|
| | | Asymmetric | Etching | |
| Classification | | Structure | Structure | Remarks |
| Glass Thickness | | 70 um/30 um | 70 um/30 um | |
| (Thick Portion/Thin | | | | |
| Portion) | | | | |
| Reinforcement Depth | | 13 um/6 um | 13 um/6 um | |
| Characteristics (DOL) | | | | |
| (Thick Portion/Thin | | | | |
| Portion) | | | | |
| Bending | Glass | Average 0.50 | Average 0.12 | Raised Height - |
| | | Maximum 1.56 | Maximum 0.32 | Substrate |
| | | | | Thickness |
| | After Glass | 0.8 | 0~0.2 | The same as |
| | Protective Coating | | | above |

| | | |
|---|---|---|
| Visibility of Boundary Crease | Weak | Not visible |
| between Heterogeneous | | |
| Thicknesses | | |

In Tables 2 and 3, the single-sided asymmetric structure refers to a case in which recessed portions are formed on only one surface of the window, and the double-sided etching structure refers to a case in which recessed portions are formed on both surfaces of the window.

Referring to Tables 2 and 3, it may be seen that when recessed portions are formed on both sides of the window, the bending phenomenon is improved compared to other cases. The bending phenomenon may be generally caused by an imbalance in stress that occurs during chemical reinforcement, and in the case of such a double-sided etching structure, the recessed portions are formed at least symmetrically on each opposing surface, thereby making it possible to distribute and balance the stresses caused by expansion during the chemical reinforcement to improve shape distortion.

Furthermore, according to an embodiment of the disclosure, it is possible to minimize shape distortion by chemically reinforcing each of the thick portion and the thin portion under different conditions. In an embodiment, the chemical reinforcement may be performed based on the thickness of the thick portion for the thick portion and based on the thickness of the thin portion for the think portion. As described above, the expansion length of each portion may be made substantially the same, and its shape distortion may be minimized, by making the DOL of each of the thick portion and the thin portion proportional to each thickness.

Further, according to an embodiment of the disclosure, a coating material may be coated onto an outer surface of a display module or a front surface of a window. In an embodiment, the coating material may be provided with a composition different from that of the adhesive member or may be replaced with the adhesive member. In an embodiment, the coating material may have high transparency. In an embodiment, the coating material may have the same or corresponding light refractive index as that of the window.

In an embodiment, the coating material may be generally solidified by ultraviolet rays or thermal energy sources. The coating material may have a volume shrinkage rate ranging from 3% to 4%, and the degree of shrinkage may increase as a step difference between a thick portion and a thin portion increases. That is, the larger the step difference between the thick portion and the thin portion, the greater the bending phenomenon of the window, which may deteriorate its displaying quality.

In an embodiment, the window may have an upper recessed portion and a lower recessed portion on both surfaces, respectively, and when the upper and lower recessed portions are provided, the step difference may be lowered up to at least 50% compared to when the recessed portion is provided only on a single surface. For example, assuming that the step difference between the thick portion and the thin portion is X μm, for the recessed portion provided on only a single surface, the step difference between the thick portion and the thin portion may be reduced to X/2 μm in case where the recessed portions are provided on both surfaces. As a result, in the case of the window with recessed portions on both surfaces, the shrinkage stress generated on each surface during the curing of the coating material may be offset against each other, thereby resulting in excellent appearance quality. For a more concrete example, in case where a coating material having a shrinkage rate of 4% is coated on a window and then cured, assuming a structure in which a thick portion has a thickness of 70 μm and a thin portion has a thickness of 30 μm and recessed portions are formed on both surfaces, a step difference between the thick portion and the thin portion may be reduced to 20 μm compared to a structure in which the recessed portion is formed on a single surface. In such a structure, the shrinkage stress may act symmetrically on the upper and lower surfaces, and consequently, a window with a flat appearance and a better quality can be obtained.

According to an embodiment of the disclosure, delamination between a glass member and an adhesive member may be minimized. Further, according to an embodiment, deformation in shape of a window, which may be caused during a process for the glass member (e.g., a chemical reinforcement process) or a process for the window (e.g., a UV curing process for the adhesive member) may be minimized.

The effects that can be obtained from example embodiments of the disclosure are not limited to those described above, and other effects not mentioned herein may be clearly derived and understood by those having ordinary knowledge in the technical field to which the example embodiments of the disclosure belong from the following description. In other words, unintended effects of practicing the example embodiments of the disclosure may be also derived from the example embodiments of the disclosure by those having ordinary knowledge in the art.

The electronic device according to various embodiments of the disclosure may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

The various embodiments and terms used herein are not intended to limit the technical features described herein to specific embodiments and should be understood to include various modifications, equivalents, or substitutes of the embodiment. In connection with the description of the drawings, like reference numerals may be used for similar or related components. In this document, each of the phrases such as “A or B,” “at least one of A and B,” “at least one of A or B,” “A, B or C,” “at least one of A, B and C,” and “at least one of A, B, or C” may include any one of the items enumerated together in a corresponding one of the phrases, or all possible combinations thereof. Terms such as “the first,” “the second,” or “first,” or “second” may be used simply to distinguish a corresponding component from another corresponding component, and do not limit the corresponding components in view of other aspect (e.g., importance or order). It is to be understood that if an element (e.g., a first element) is referred to, with or without the term “operatively” or “communicatively,” as “coupled with,” “coupled to,” “connected with,” or “connected to” another element (e.g., a second element), it denotes that the element may be coupled with the other element directly (e.g., wiredly), wirelessly, or via a third element.

The term “module” used in various embodiments of the document may include a unit implemented in hardware, software, or firmware and be used interchangeably with terms such as logic, logic block, part, component, or circuitry, for example. The module or unit may be a minimum unit or a part of the integrally configured component or the component that performs one or more functions. For example, according to an embodiment, the module or unit may be implemented in the form of an application-specific integrated circuit (ASIC).

Various embodiments as set forth herein may be implemented as software (e.g., the program 140) including one or more instructions that are stored in a storage medium (e.g., an internal memory 136 or an external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply denotes that the storage medium is a tangible device, and does not include a signal (e.g., an electromagnetic wave), but this term does not differentiate between where data is semi-permanently stored in the storage medium and where the data is temporarily stored in the storage medium.

According to an embodiment of the disclosure, a method according to various embodiments of the disclosure may be included and provided in a computer program product. The computer program product may be traded as a product between a seller and a buyer. The computer program product may be distributed in the form of a machine-readable storage medium (e.g., a compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments of the disclosure, each component (e.g., a module or a program) of the above-described components may include a single entity or multiple entities, and some of the multiple entities may be separately disposed in different components. According to various embodiments of the disclosure, one or more of the above-described components may be omitted, or one or more other components may be added. Alternatively or additionally, a plurality of components (e.g., modules or programs) may be integrated into a single component. In such a case, according to various embodiments of the disclosure, the integrated component may still perform one or more functions of each of the plurality of components in the same or similar manner as they are performed by a corresponding one of the plurality of components before the integration. According to various embodiments of the disclosure, operations performed by the module, the program, or another component may be carried out sequentially, in parallel, repeatedly, or heuristically, or one or more of the operations may be executed in a different order or omitted, or one or more other operations may be added.

The embodiments of the disclosure disclosed in the specification and the drawings provide merely specific examples to easily describe technical content according to the embodiments of the disclosure and help the understanding of the embodiments of the disclosure, not intended to limit the scope of the embodiments of the disclosure. Accordingly, the scope of various embodiments of the disclosure should be interpreted as encompassing all modifications or variations derived based on the technical spirit of various embodiments of the disclosure in addition to the embodiments disclosed herein.

What is claimed is:

1. An electronic device comprising:
a housing; and
a display module having a first region, a second region and a third region between the first region and the second region, comprising:
a window comprising a first portion having a first thickness in the first region, a second portion having a second thickness in the second region, the second thickness being less than the first thickness, and a recessed portion in the third region,
an adhesive member disposed on at least one surface of the window, and
a display panel attached to the window;
wherein the recessed portion has a first radius of curvature between the first region and the third region, a second radius of curvature between the second region and the third region, and a third radius of curvature at a point having a minimum thickness in the recessed portion.

2. The electronic device of claim 1, wherein the first radius of curvature is greater than or equal to at least one of the second radius of curvature and the third radius of curvature.

3. The electronic device of claim 1, wherein the recessed portion comprises a first curved portion having the first radius of curvature, a second curved portion having the second radius of curvature, and a third curved portion having the third radius of curvature, and
wherein the first curved portion comprises an inclined portion having an inclination of 1 degree or less.

4. The electronic device of claim 1, wherein a first outer edge forming a boundary between the first region and the third region is positioned opposite to a second outer edge forming a boundary between the second region and the third region.

5. The electronic device of claim 1, wherein the recessed portion is on a first surface of the window, and
wherein a second surface of the window that is opposite to the first surface of the window is flat.

6. The electronic device of claim 1, wherein the recessed portion is on a first surface of the window and a second surface of the window that is opposite the first surface of the window.

7. The electronic device of claim 1, wherein the display module is configured to be folded at the second region and the third region while the first region remains flat.

8. The electronic device of claim 1, wherein at a boundary between the first region and the third region, the recessed portion has the first thickness, and
wherein, at a boundary between the second region and the third region, the recessed portion has the second thickness.

9. The electronic device of claim 1, wherein the recessed portion comprises a first inclined portion adjacent to the first region and a second inclined portion adjacent to the second region, and
wherein the point at which the recessed portion has the minimum thickness corresponds a point where the first inclined portion meets the second inclined portion.

10. The electronic device of claim 1, wherein the window further comprises a reinforced portion and a non-reinforced portion surrounded by the reinforced portion.

11. The electronic device of claim 10, wherein, in the third region, the reinforced portion comprises a first reinforced portion having a depth of layer (DOL) in a range of 10% to 20% of the first thickness of the first portion of the window and a second reinforced portion having the DOL in a range of 10% to 20% of the second thickness of the second portion of the window.

12. The electronic device of claim 1, wherein the electronic device further comprises a first layer component arranged on an upper side of the window and a second layer component arranged on a lower side of the window;
wherein a first adhesive member of the adhesive member has a first length from an upper surface of the window to a lower surface of the first layer component in the first region, a second length from the upper surface of the window to the lower surface of the first layer component in the second region, the second length being greater than the first length, and a third length from the upper surface of the window to the lower surface of the first layer component in the third region, the third length being greater than or equal to the second length.

13. The electronic device of claim 12, wherein a second adhesive member of the adhesive member has a fourth length from the lower surface of the window to an upper surface of the second layer component, in the first region, the second region and the third region.

14. The electronic device of claim 12, wherein a second adhesive member of the adhesive member has a fifth length from a lower surface of the window to an upper surface of the second layer component in the first region, a sixth length from the lower surface of the window to the upper surface of the second layer component in the second region, the sixth length being greater than the fifth length, and a seventh length from the lower surface of the window to the upper surface of the second layer component in the third region, the seventh length being greater than or equal to the sixth length.

15. The electronic device of claim 1, wherein
the first thickness of the first portion of the window is 40 um to 500 um.

16. The electronic device of claim 1, wherein
the second thickness of the second portion of the window is 10 um to 40 um

17. The electronic device of claim 1, further comprising,
a support plate supporting the display module and having a plurality of slit holes in the second region and the third region.

18. The electronic device of claim 1, further comprising,
a hinge structure coupled to the housing in the third region, and
wherein the display module is configured to fold by the hinge structure,

19. An electronic device comprising:
at least one housing;
a display module having a first region, a second region and a third region between the first region and the second region, comprising:
a window comprising a first portion having a first thickness in the first region, a second portion having a second thickness in the second region, the second thickness being less than the first thickness, and a recessed portion in the third region;
a support plate supporting the display module and having a plurality of slit holes in the second region and the third region;
a multi-bar assembly coupled to the display module and configured for sliding-in or sliding-out the display module; and
a drive module coupled to the multi-bar assembly,
wherein the recessed portion of the window has a first radius of curvature between the first region and the third region, a second radius of curvature between the second region and the third region, and a third radius of curvature at a point having a minimum thickness in the recessed portion.
